(19) United States
(12) Patent Application Publication
(10) Pub. No.: US 2006/0205343 A1
(43) Pub. Date: Sep. 14, 2006

(54) Wireless repeater with feedback suppression features

(76) Inventors: Donald L. Runyon, Duluth, GA (US); Stephen Brett Thompson, Norcross, GA (US); James William Maxwell, Atlanta, GA (US); David L. McKay SR., Duluth, GA (US)

Correspondence Address: MEHRMAN LAW OFFICE, P.C., ONE PREMIER PLAZA, 5605 GLENRIDGE DRIVE, STE. 795, ATLANTA, GA, 30342, US

(21) Appl. No.: 11/373,061

(22) Filed: Mar. 11, 2006

Related U.S. Application Data
(60) Provisional application No. 60/660,928, filed on Mar. 11, 2005.

(51) Int. Cl. H04B 7/15

(52) U.S. Cl. 455/11.1

(57) ABSTRACT

A wireless repeater with features that improve the server-donor antenna isolation including multi-purpose server and donor mounting plates that each carry an antenna feed circuit board and associated antenna elements mounted in a back-to-back arrangement with the duplex repeater electronics board sandwiched between the server and donor mounting plates. To improve the server-donor antenna isolation, one or both mounting plates may include corner, side tabs, which may be asymmetric, and raised walls around one or both mounting plates. In addition, the radomes covering the donor antenna and/or the server antennas may carry one or more parasitic conductors, such as a two parasitic strips arranged in parallel lines or for parasitic strips arranged in a square configuration.

### REFERENCE TO RELATED APPLICATIONS

This application claims priority to commonly-owned copending U.S. Provisional Patent Application Ser. No. 60/660,928 entitled “Improved Cellular Signal Enhancer” filed Mar. 11, 2005, which is incorporated herein by reference. This application also incorporates by reference commonly-owned copending U.S. patent application Ser. No. 10/375,879 entitled “Cellular Signal Enhancer” filed Feb. 26, 2003, which is also incorporated herein by reference. This application further incorporates by reference commonly-owned copending U.S. patent application Ser. No. 11/127,668 entitled “Mounting Pedestal For A Cellular Signal Enhancer” filed May 13, 2005.

### TECHNICAL FIELD

The present invention is generally related to wireless repeaters, which are also referred to as cellular signal enhancers. More particularly, the invention relates to a wireless repeater with feedback suppression features including mechanical tabs, raised walls, circuit board isolation compartments disposed within multi-purpose antenna mounting plates, and parasitic conductors located adjacent to the antenna elements.

### BACKGROUND OF THE INVENTION

Wireless repeaters, which are also referred to as cellular signal enhancers, serve an important function in the cellular telephone industry, as described in U.S. patent application Ser. No. 10/375,879 referenced above. They can be implemented as portable “personal repeater” units that receive, amplify and repeat bidirectional wireless telephone signals between cellular base stations and wireless telephones located in a structure, typically a home or office, where low signal strength from the base station causes degraded service or, in some cases, no service at all. In addition, low signal strength causes the wireless telephone to increase its transmission power, which drains the battery more quickly. This makes the wireless repeater an important, if not indispensable, piece of equipment for a wide range of customers, including the increasing number of customers who rely on wireless telephone service exclusively and, therefore, do not have a land line alternative available in their homes or businesses. Sufficiently reliable wireless telephone service is also especially important for those who rely on wireless telephone service for data communications, such as Internet access, credit card transactions, intranet communications with a remote office location, and the like.

In order to foster competition among wireless telephone and data communication service providers (also referred to as “carriers”), the prevailing authorities have allocated fairly broad sections of the RF frequency spectrum to this particular type of service. As a standard adopted in the U.S., Europe and elsewhere, these fairly large portions of the frequency spectrum include the United States (US) cellular frequency band between 824 MHz and 894 MHz, and the Universal Mobile Telecommunication Service (UMTS) in frequency range of 1710 MHz through 2170 MHz that includes the spectrum of PCS-1900 and GSM-1800 digital systems. These relatively large sections of the frequency spectrum have been subdivided into smaller bands and sub-bands that have been auctioned and thereby licensed or otherwise assigned or licensed to different carriers, thereby fostering competition among the carriers in the provision of licensed wireless telephone and data services.

Although the overall frequency range allocated to wireless telephone and data communication service is standardized in regions of the world, the particular frequency channel profile varies significantly. That is, the manner in which the overall frequency range has been divided into channels varies from region to region. In the United States, for example, channels having 15 MHz bandwidth in the PCS-1900 digital system were initially auctioned to carriers in different geographic areas. In some of these regions, these 15 MHz main bands have been further subdivided into 5 MHz sub-bands operated by different carriers. Although the 15 MHz main bands have not been subdivided in certain other regions, it is possible that they will be subdivided sometime in the future. Other countries have instituted their own channel profiles, which are generally different from the channel profiles in other countries, including the US. In addition, the identification of the specific licensed carriers providing service almost always varies from region to region. While this was the intended result of the spectrum auction process, the resulting variation in the frequency channel profile from region to region presents a challenge for the designers of wireless repeaters intended for installation in the premises of the end-use customers, mainly homes and offices.

Although wireless repeaters have been developed that permit the user to select among a variety of frequency bands within a predefined channel profile, prior wireless repeaters have not permitted the channel profile itself to be reconfigured. As a result, the same wireless repeater unit cannot be used in different regions that have implemented different channel profiles. This prevents, for example, the same wireless repeater from working in both the United States and in Europe or among different countries within Europe. There is, therefore, a need for a wireless repeater that can be used in any service area using the same overall frequency range, regardless of the different frequency channel profiles existing in the different service areas.

Moreover, all of the wireless repeaters installed in a particular service area could require reconfiguration to update the frequency channel profile in the event of a change in the licensed frequency channel profile in that service area. This means that the installation of a large number of wireless repeaters in a service area where the 15 MHz main band has not yet been subdivided could effectively discourage the subdivision of the main band in the service area into 5 MHz sub-bands. To prevent this undesirable turn of events from coming to fruition, there is a present need for a wireless repeater that does not have to be discarded or returned to the factory for reconfiguration to accommodate a change in the frequency channel profile within the service area where the unit is located.

Because a portable wireless repeater is designed to be installed in homes and businesses, it is also desirable for the units to be as inconspicuous and aesthetically pleasing as possible. This generally means making the unit as small as possible and implementing the unit within a single enclosure, which also reduces the cost and weight in most instances. Making the unit wireless repeater small and deployed in a single housing, however, brings the server and donor antennas into close proximity. This generally increases the tendency of the repeater to develop positive feedback instability, thereby limiting the gain that can be effectively applied by the unit. Innovations that help to alleviate positive feedback instability by improving server-donor antenna feedback suppression are therefore desirable to permit reduced size of the unit, increased gain, and improved signal quality. Accordingly, there is an ongoing need for techniques that improve the server-donor antenna feedback suppression in a wireless repeater. This capability should be implemented in a cost effective, reliable, flexible and sturdy manner to the extent possible.

### SUMMARY OF THE INVENTION

The present invention meets the needs described above in a wireless repeater with a number of mechanical features designed to improve the server-donor feedback suppression of the unit. These features include a multi-purpose mounting plate for the donor antenna that supports the donor antenna feed circuit board and associated donor antenna elements mounted on one side of the multi-purpose mounting plate, and the duplex repeater electronics board mounted on the other side. The server side has a similar multi-purpose configuration with the server antenna feed circuit board mounted to one side and the duplex repeater electronics board sandwiched between the server and donor mounting plates. In this configuration, the donor and server antennas are supported within an common enclosure and pointed in opposite directions. In other words, to provide a compact and portable wireless repeater unit, the server and donor antennas are housed within a common enclosure in a back-to-back configuration with the server and donor antennas pointing in opposite directions, such that the unit can be placed in a window with the donor antenna pointing out the window and the server antenna pointing into the structure.

To enhance the server-donor antenna isolation, one or both mounting plates may include corner tabs and/or side tabs, which may be asymmetric, and raised walls around one or both mounting plates. In addition, the radomes covering the donor antenna and/or server antennas may carry one or more parasitic conductors, such as a two parasitic strips arranged in parallel lines or for parasitic strips arranged in a square configuration. To provide electromagnetic isolation in a light weight structure, the multi-purpose mounting plate is preferably manufactured from aluminum.

Generally described, the invention may be implemented as a wireless repeater that includes a duplex repeater electronics board and a donor mounting plate carrying the repeater electronics board one side and a donor antenna feed circuit on an opposing its opposing side. The wireless repeater also includes a server mounting plate carrying the repeater electronics board one side and a server antenna feed circuit on an opposing its opposing side. The donor mounting plate, the server mounting plate, and the duplex repeater electronics board are affixed to each other to form an integral housing. As arranged in the integral housing, the donor antenna can be orientated in an operable donor direction for exchanging duplex cellular communication signals with one or more base stations, while the server antenna can orientated in an operable server direction for exchanging duplex cellular communication signals with one or more wireless telephone units. The operable donor direction and the operable server direction are preferably opposite each other.

The server and/or donor mounting plates may also include one or more walls forming one or more isolation zones that substantially enclose certain portions of the electronic board to reduce the release of electromagnetic energy radiating from these zones of the electronic board. The server and/or donor mounting plates may also include one or more corner tabs for reducing the amount of energy radiated by the donor antenna that propagates around the common housing and into the server antenna. Further, the server and/or donor mounting plate may include one or more corner tabs for reducing the amount of energy radiated by the donor antenna that propagates around the common housing and into the server antenna. Some or all of these features may also be arranged in asymmetrical sets.

Alone or in combination with one or more of these features, the wireless repeater may also include a first radome covering the donor antenna, a second radome covering the server antenna, and one or more parasitic conductors carried by one or both of the first and second radomes. For example, the parasitic conductors may be strips arranged in parallel lines or a square configuration. For any of the embodiments, the wireless repeater may include a user-operable frequency range selector for identifying a selected frequency range and a display for showing information connoting the selected frequency range. In this case, the wireless repeater is operable for providing wireless repeater service within the selected frequency range.

In view of the foregoing, it will be appreciated that the present invention provides a wireless repeater with a number of features that improve the server-donor feedback suppression of the device. The specific techniques and structures for implementing this invention will become apparent from the following detailed description of the embodiments and the appended drawings and claims.

### BRIEF DESCRIPTION OF THE DRAWINGS

FIG. 1 is a conceptual illustration of a wireless repeater with a communication port that implements dual cross-polarization isolation.

FIG. 2A is a front view (server side) of a wireless repeater.

FIG. 2B is a conceptual illustration of the wireless repeater in an illustrative operating environment.

FIG. 3 is a conceptual illustration of a layered configuration of the wireless repeater.

FIG. 4 is a conceptual illustration of a frequency band selection and associated display feature for the wireless repeater.

FIG. 5 is a functional block diagram the wireless repeater.

FIG. 6 is a conceptual illustration of a wireless repeater that is remotely accessible.

FIG. 7 is a partially exploded view of the wireless repeater.

FIG. 8 is an exploded view of the wireless repeater.

FIG. 9 is an assembled perspective view the server side of the wireless repeater with radomes removed.

FIG. 10 is an assembled perspective view the donor side of wireless repeater with radomes removed.

FIG. 11 is a front view of the server antenna feed circuit for the wireless repeater with balanced antenna feeds and horizontal polarization for the downlink circuit, and unbalanced antenna feeds and vertical polarization for the uplink circuit.

FIG. 12 is a front view of a donor antenna feed circuit for the wireless repeater with balanced antenna feeds and vertical polarization for the downlink circuit, and unbalanced antenna feeds and horizontal polarization for the uplink circuit.

FIG. 13 is a front view of a server antenna feed circuit for the wireless repeater with balanced antenna feeds and horizontal polarization for the downlink circuit, and balanced antenna feeds and vertical polarization for the uplink circuit.

FIG. 14 is a front view of a donor antenna feed circuit for the wireless repeater with balanced antenna feeds and vertical polarization for the downlink circuit, and balanced antenna feeds and horizontal polarization for the uplink circuit.

FIG. 15 is a perspective view of a server radome for the wireless repeater carrying two vertical parasitic strips for improving the server-donor antenna isolation of the wireless repeater.

FIG. 16 is a perspective view of a donor radome for the wireless repeater carrying two vertical and two horizontal parasitic strips in a square configuration for improving the server-donor antenna isolation of the wireless repeater.

FIG. 17 is a perspective view the donor mounting plate for the wireless repeater showing isolation zones for improving the server-donor antenna isolation of the wireless repeater.

FIG. 18 is a detailed circuit diagram of the electronics board of the wireless repeater.

### DETAILED DESCRIPTION

The present invention may be implemented as an improvement to the wireless repeater described in commonly-owned copending U.S. patent application Ser. No. 10/375,879 entitled “Cellular Signal Enhancer” filed Feb. 26, 2003. The present invention may be embodied in a wireless repeater suitable for use in a building or other structure, such as a home or business. Several embodiments are shown and described below that each include a number of features to improve the server-donor feedback suppression, which is also referred to as isolation. These features include a multi-purpose mounting plate for the donor antenna that includes the donor antenna feed circuit board and associated donor antenna elements mounted on one side of the multi-purpose mounting plate, and the duplex repeater electronics board mounted on the other side. The server side has a similar configuration, with the donor and server antennas pointed in opposite directions and the duplex repeater electronics board sandwiched between the donor and server mounting plates. To provide electromagnetic isolation in a light weight structure, the multi-purpose mounting plate is preferably made from aluminum. However, any other suitable material may be used. To further improve the server-donor antenna isolation, one or both mounting plates may include corner and/or side tabs, which may be asymmetric, and raised walls around one or both mounting plates.

In addition, the radomes covering the donor antenna and/or the server antenna may carry one or more parasitic conductors, such as a two parasitic strips arranged in parallel lines or for parasitic strips arranged in a square configuration. Other configurations of parasitic conductors could also be used. Like the other mechanical server-donor antenna isolation techniques, the parasitic strips are designed to narrow the antenna beam and reduce the sidelobe energy. The parasitic strips can be implemented using conductive (e.g., copper) tape, printed conductor traces, metal strips attached with appropriate fasteners, or any other suitable type of conductive material. An inexpensive, light weight copper tape has been found to be a good option for this element.

It should be understood that the term “cellular” as used in this specification is not limited to the US wireless communication service in the frequency band between 824 MHz and 894 MHz that is often referred to as “cellular” service, but instead covers all types of analog and digital wireless voice and data communication services in all operable frequency bands. In addition, the wireless repeater can be used to provide improved wireless communication service to a number of different types of wireless communication devices (also referred to as wireless units), such as hand-held telephones, PDAs, computers, wireless access points, video conferencing systems, building access systems, inventory monitoring systems, security systems, financial transaction systems, and other types of devices engaging in wireless voice and/or data communications.

Therefore, it should be understood that “wireless communication services” are not limited to conventional wireless telephone service and, in particular, include any other type of wireless data service, such as data communication service carried on the overhead data channel of the existing wireless communication network. Similarly, a “wireless communication device” or “wireless unit” is not limited to a voice-channel device and, in particular, is not limited to a conventional wireless telephone. Accordingly, a “wireless communication service provider” or “carrier” for short is not limited to a wireless telephone service provider. Nevertheless, is should also be appreciated that providing improved wireless telephone and data service is the principle intended application of the particular embodiments of the invention described below.

The antenna feed circuits employed in the preferred embodiments include transmission signal traces printed on a suitable dielectric printed circuit (PC) board panel commonly known as a “microstrip” RF circuit configuration. For this type of circuit operating at a carrier frequency of 1.92 GHz (which is the center frequency of the authorized PCS-1900 wireless telephone band), a typical dielectric material (e.g., PTFE Teflon®) having a dielectric constant equal to 2.2 (εᵣ=2.2) can be used to construct the PC boards. This material exhibits an effective dielectric constant of 1.85 (ε_{reff}=1.85) for printed transmission signal traces exposed to the PC board on one side and exposed to air on the other side. For this type of PC board circuit, the wavelength in the guide (λ_{g}) (i.e., the wavelength as propagating in the transmission signal trace as laid out on the PC board with one side exposed to the dielectric substrate and the other side exposed to air) is approximately 4.52 inches (11.48 cm). It is well known to someone familiar with the art of antenna design that using a substrate material having a higher dielectric constant value can reduce the overall size of the circuit. Materials with substantially higher dielectric constant values can be more expensive, can have higher RF signal losses, and can have RF power handling limitations that are a lower value due to reduced stripline trace width values. It is also desirable to have a circuit with sufficiently wide conducting trace width values and low RF signal loss characteristics for conditions of moderate to high operational RF power levels. Generally, the use of a substrate material with a low dielectric constant value is often desirable when RF power levels are a significant design consideration.

Moreover, the preferred radiating antenna elements are square, microstrip patch antennas elements. A radiating element that is on the same printed substrate and directly interfaced to the microstrip feed circuit can operate with a parasitic patch radiating element that is separated from the antenna feed circuit by thin dielectric foam spacers. As a result, the parasitic antenna elements are electromagnetically coupled to the antenna feed circuits and the parasitic element arrangement can provide an increased operational bandwidth when compared to a microstrip patch antenna element on a thin substrate. But this configuration is merely illustrative as a particular embodiment for implementing the invention, and skilled antenna engineers will understand how to practice the invention using different types of antenna elements and feed circuit couplings. Those skilled in the art of antenna design will also appreciate how to design equivalent antenna feed circuits, radiating antenna elements, and associated components using other types of microstrip PC board substrates and other RF circuit board configurations, such as those commonly known as “stripline,” “tri-plate,” “air microstrip” and any other suitable type of RF circuit board.

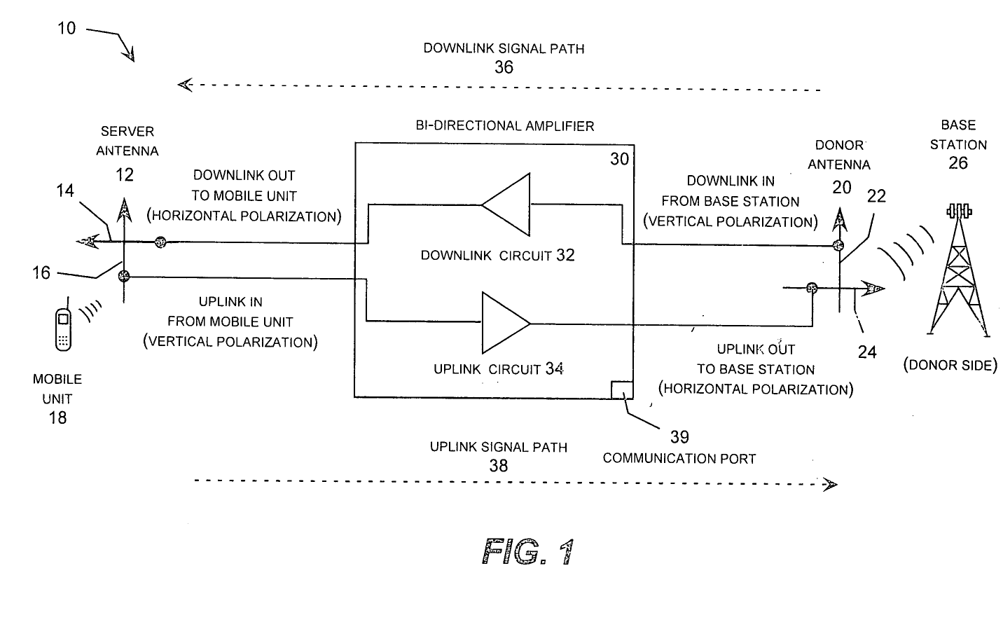

Turning now to the drawings, in which like numerals refer to like elements throughout the several figures, FIG. 1 is a conceptual drawing of the wireless repeater unit illustrating “dual cross-polarization isolation,” which is a feedback suppression technique suitable for use in compact wireless repeaters. This feedback suppression technique is disclosed in the commonly-owned copending U.S. patent application Ser. No. 10/375,879 entitled “Cellular Signal Enhancer” filed Feb. 26, 2003. Like this prior application, the present application describes a wireless repeater that is suitable for installation and use in the premises of wireless telephone service end-use customers, such as the customer's home or office. To make the wireless repeater unit portable and appropriately sized for this intended application, the unit includes two antennas, known as the donor and server antennas, and a bidirectional amplifier (“BDA”) housed within a single, portable, self-contained enclosure. The entire unit has size, weight and cost characteristics that make it suitable for installation in the customer's premises. The unit is also configured to be easily handled and installed by most people with a few ordinary tools and minimal assembly. A mounting pedestal and associated features of the wireless unit designed to facilitate easy installation of the unit in the customer's premises are described in commonly-owned copending U.S. patent application Ser. No. 11/127,668 entitled “Mounting Pedestal For A Cellular Signal Enhancer” filed May 13, 2005.

While locating both antennas very close to each other within a single housing has advantages for a portable customer-premises device, it also increases the tendency of the device to incur feedback instability. Conventional options for avoiding feedback instability include physically separating the antennas, electromechanical shielding techniques, which have cost and weight tradeoffs, and electronic filtering and gain control, which have cost and complexity tradeoffs. Dual cross-polarization isolation, as described in more detail below, is a cost effective way to suppress feedback instability so that the antennas can be located as close to each other as possible, in this case within the same enclosure, to produce a smaller, less expensive and more convenient wireless repeater unit. The wireless repeater unit described in the present application implements dual cross-polarization isolation along with other features that improve the feedback suppression of the unit, such field programmable feedback cancellation circuits, balanced and quasi-balanced antenna feed circuits, and certain mechanical features providing feedback suppression techniques. The combination dual cross-polarization isolation with the other feedback suppression techniques described below is particularly well suited to compact wireless repeaters disposed in a common housing. These approaches can result in a smaller and less costly repeater solution in a single housing that can offer higher values of electronic gain for the size when compared to known techniques using one or more of the following: artificial magnetic conducting (AMC) surfaces, conventional choke grooves, and microwave absorbing materials.

Referring to FIG. 1 to establish relevant nomenclature, dual cross-polarization isolation is the combination of cross-polarization both along and between the uplink and downlink signal paths. As shown in FIG. 1, the wireless repeater 10 includes a server antenna 12 that includes a downlink portion 14 and an uplink portion 16. The server antenna 12 is a dual-polarization antenna, in which the downlink portion 14 has a different polarization state from the uplink portion 16. In this example, the polarization states are represented by arrows, which indicate that the downlink portion 14 of the server antenna has a horizontal polarization state, whereas the uplink portion 16 of the server antenna has a vertical polarization state. The server antenna 12 is designed to communicate with the customer's wireless communication device 18, also is called a mobile unit. Therefore, when the repeater is installed in a window, it should be positioned with the server antenna 12 facing into the structure.

The wireless repeater 10 also includes a donor antenna 20 that has a downlink portion 22 and an uplink portion 24. The donor antenna is designed to communicate with the base station 26 operated by or for the wireless communication service provider, which is also called the carrier. Like the server antenna, the donor antenna 20 is also a dual-polarization antenna, in which the downlink portion 22 has a different polarization state from the uplink portion 24. In this example, the downlink portion 22 of the donor antenna has a vertical polarization state, whereas the uplink portion 24 of the donor antenna has a horizontal polarization state.

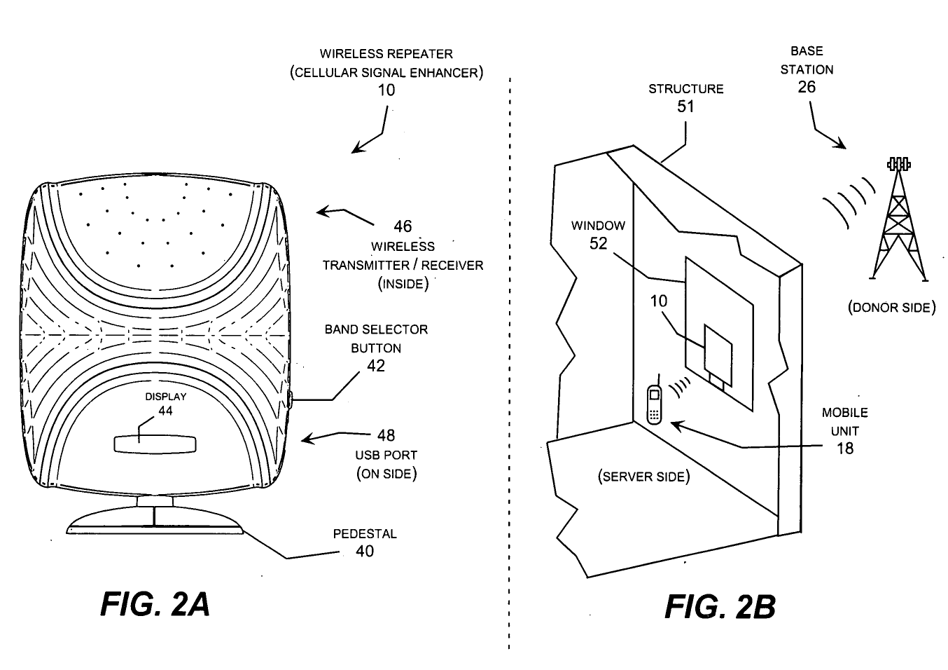

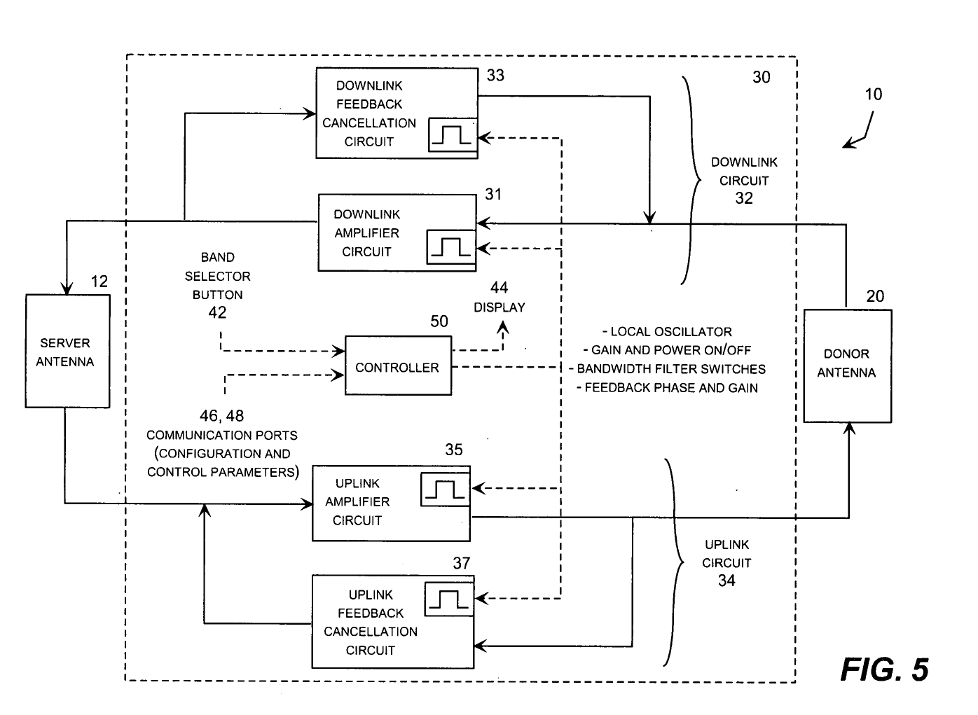

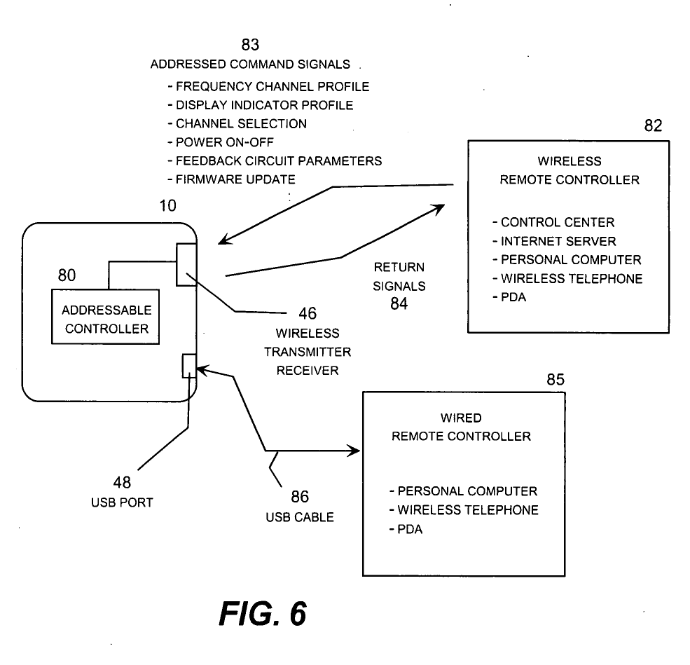

The wireless repeater 10 also includes and a bidirectional amplifier (BDA) 30 function that transmits and amplifies the communication signals between the server and donor antennas. More specifically, the BDA includes a downlink amplifier circuit 32 that receives communication signals from the downlink portion 22 of the donor antenna, amplifies theses signals and delivers them to the downlink portion 14 of the server antenna. Similarly, the BDA includes an uplink amplifier circuit 34 that receives communication signals from the uplink portion 16 of the server antenna, amplifies theses signals and delivers them to the uplink portion 24 of the donor antenna. Thus, the downlink signal path 36 refers to the communication path from the carrier's base station 26 to the customer's mobile unit 18, whereas the uplink signal path 38 refers to the communication path from the mobile unit to the base station. The wireless repeater 10 also includes one or more communication ports 39, such as the wireless transmitter/receiver 46 and USB port 48 shown on FIG. 2A, for remotely controlling and reconfiguring the unit. This aspect of the wireless repeater is described in detail below with reference to FIGS. 5 and 6.

As noted above, the server antenna 12 is a dual-polarization antenna that implements cross-polarization between the downlink portion 14 of the server antenna, which has a first polarization state (horizontal polarization), and the uplink portion 16 of the server antenna, which has a different polarization state (vertical polarization). Similarly, the donor antenna 20 is also a dual-polarization antenna that implement cross-polarization between the downlink portion 22 of the donor antenna, which has a first polarization state (vertical polarization), and the uplink portion 24 of the donor antenna, which has a different polarization state (horizontal polarization). This type of cross-polarization between the uplink and downlink portions of both the server and donor antennas is the first type of cross-polarization found in dual cross-polarization isolation.

In addition, the downlink signal path 36 also implements cross-polarization isolation along the signal path from the downlink portion 22 of the donor antenna (vertical polarization) to the downlink portion 14 of the server antenna (horizontal polarization). Likewise, the uplink signal path 38 implements cross-polarization isolation along the signal path from the uplink portion 16 of the server antenna (vertical polarization) to the uplink portion 24 of the donor antenna (horizontal polarization). This type of cross-polarization along the uplink and downlink signal paths is the second type of cross-polarization found in dual cross-polarization isolation. In short, it can therefore be said that dual cross-polarization isolation refer to the combination of cross-polarization both between and along the uplink and downlink signal paths.

FIG. 2A is a front view of a illustrative embodiment of the wireless repeater 10. The wireless repeater sits on a pedestal 40, which is described in commonly-owned copending U.S. patent application Ser. No. 11/127,668 entitled “Mounting Pedestal For A Cellular Signal Enhancer” filed May 13, 2005. FIG. 2A also shows that the wireless repeater includes a band selection button 42, which allows the user to adjust the wireless repeater to a predetermined desired frequency channel corresponding to a desired wireless communication service provider. The wireless repeater also includes an associated display 44, that shows a frequency band indicator connoting the frequency channel (and corresponding licensed carrier) that user has toggled to using the band selection button. As described in more detail with reference to FIG. 5, the band selection button allows the user to adjust the unit within an operational frequency range to select an operational frequency channel from a number of selectable frequency channels. The set of selectable frequency channels is referred to as the “frequency channel profile,” and the set of channel indicators displayed on the wireless repeater to identify the associated channels is referred to as the “display profile.” The frequency channel profile typically includes a number of frequency main bands and sub-bands, which are operated by various carriers, to provide competition in the provision of wireless communication service. The band selection button 42 allows the user to adjust the wireless repeater 10 to frequency channels operated by different carriers, and therefore allows the user to change service providers without having to replace the wireless repeater unit.

FIG. 2A also shows a that the unit includes communication ports, in this embodiment a wireless transmitter/receiver 46 and a Universal Serial Bus (USB) port 48, that can be used to functionally access the controller of the wireless repeater 10 for a variety of purposes, such as reconfiguring and controlling the unit after it has been installed in the customer's premises. As noted previously, the reconfigurable parameters and settings typically include the frequency channel profile and associated display profile, frequency channel selection, power level and on-off, uplink and downlink amplifier gain settings, feedback circuit parameters, and system firmware. Of course, other parameters and setting may be subject to remote control, as desired. Also, the type of port configuration is not limited to a USB. As technology for low-cost serial communication port evolves for speed and ease of use it is expected that the USB configuration may be replaced by FIREWIRE (IEEE-1394) or some other configuration of serial communications port. As described in more detail with reference to FIG. 6, controller access by way of the communication ports can be used to customize the wireless repeater for the particular manner of installation, as well as initializing, interrogating, reprogramming, troubleshooting, upgrading the device, and so forth.

FIG. 2B is a conceptual illustration of the wireless repeater 10 in an illustrative operating environment, such as a home or business structure 51. In order to provide improved wireless telephone and data service within the structure, the wireless repeater is designed to be installed in a window 52 with the “donor side” pointed out the window for bi-directional communication with a variety of base station antennas, represented by the base station antenna 26. As noted previously, the various bases station antennas (several may be attached to a single tower or other support structure) are generally operated by different service providers using different licensed frequency channels. The wireless repeater 10 may have non-line-of-sight (N-LOS) communications with the base station 26 and therefore the optimum orientation of the repeater 10 donor antenna may be in a direction different than the geographical direction. Once installed, the “server side” of the wireless repeater, which is located on the opposite side of the device from the donor side, is pointed toward the inside of the structure where it provides bi-directional wireless repeater service for one or more mobile units, represented by the mobile unit 18, located within or near the structure. That is, the wireless repeater 10 includes a donor antenna, a server antenna, and a duplex repeater (also referred to as a bidirectional amplifier) unit in a single enclosure with the donor and server antennas pointed in opposing directions. This is the same basic configuration shown in commonly-owned copending U.S. patent application Ser. No. 10/375,879, discussed previously.

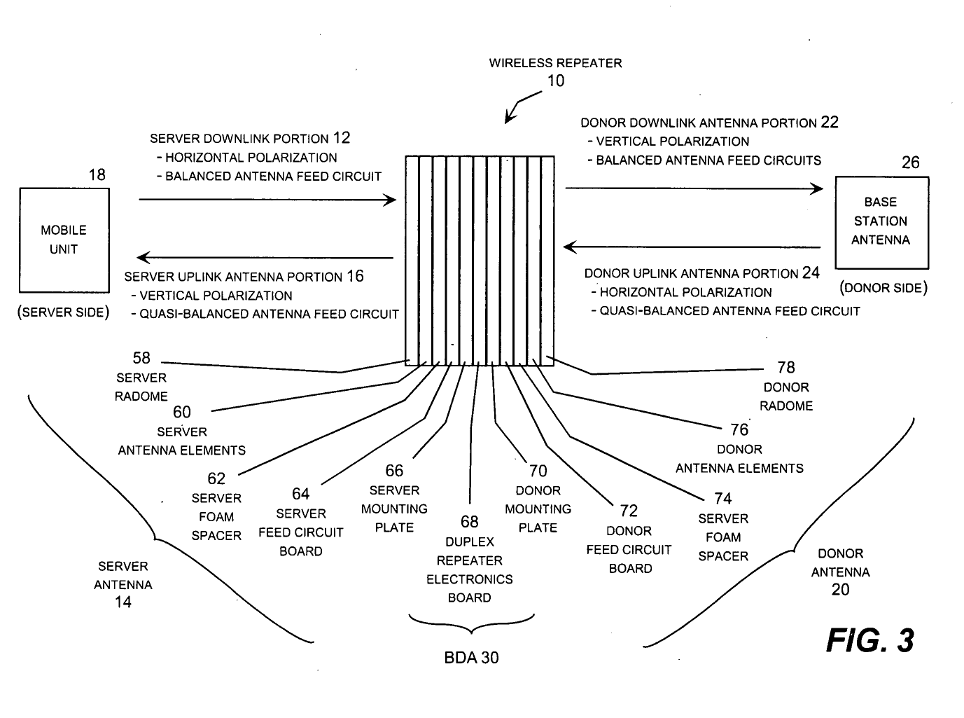

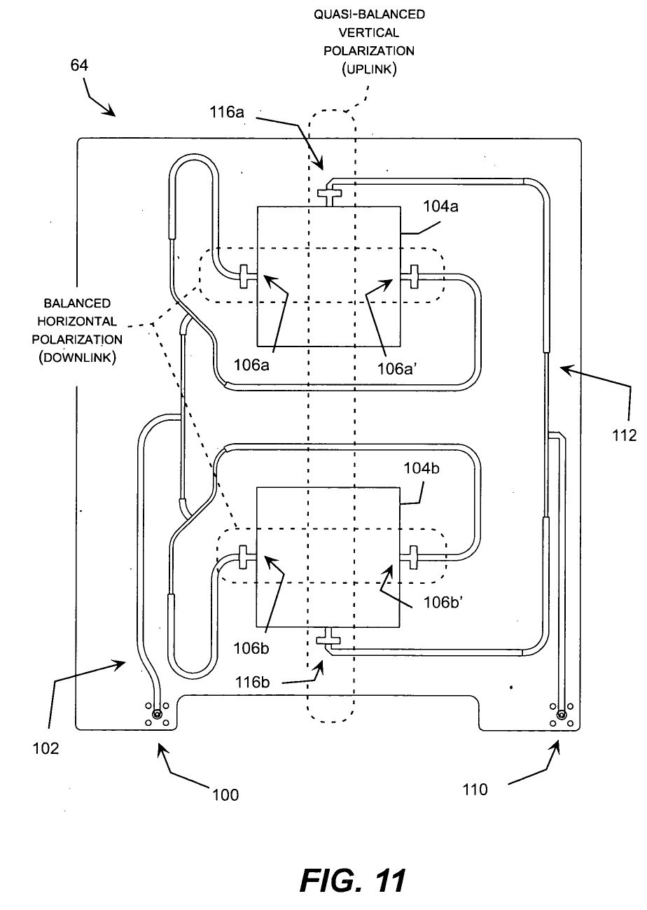

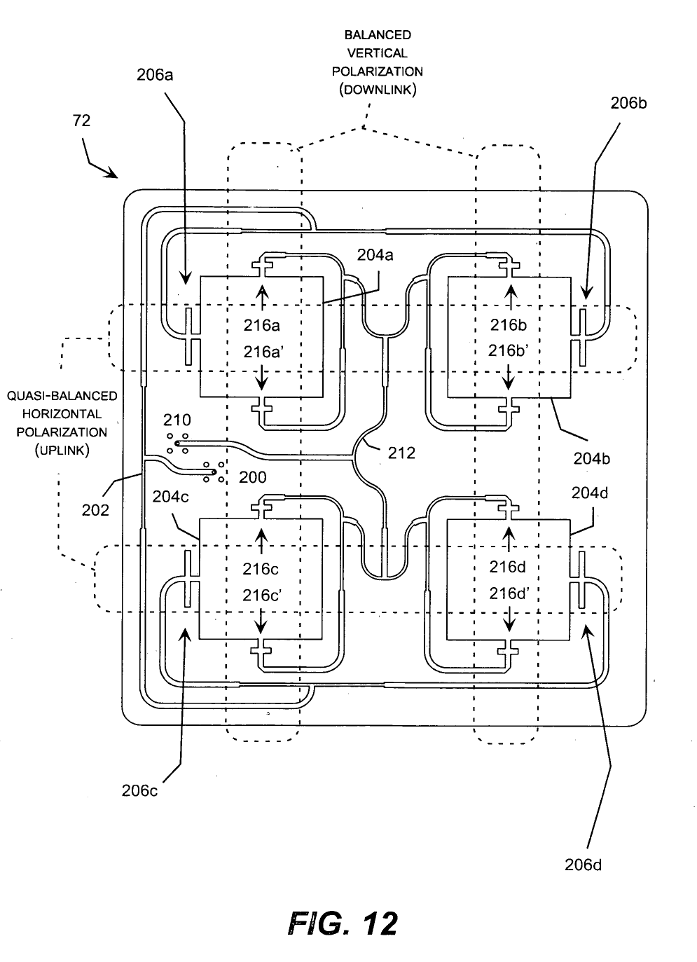

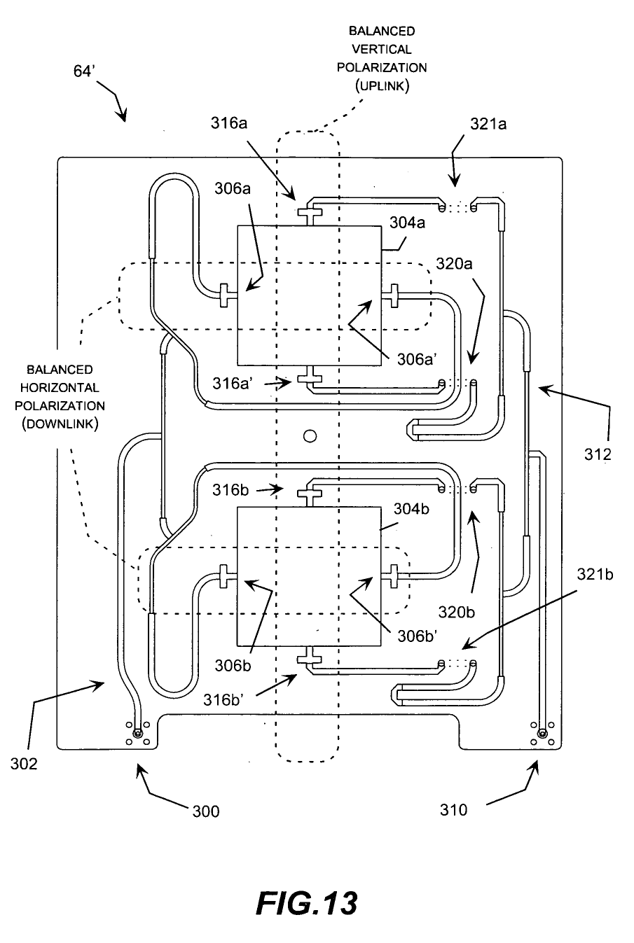

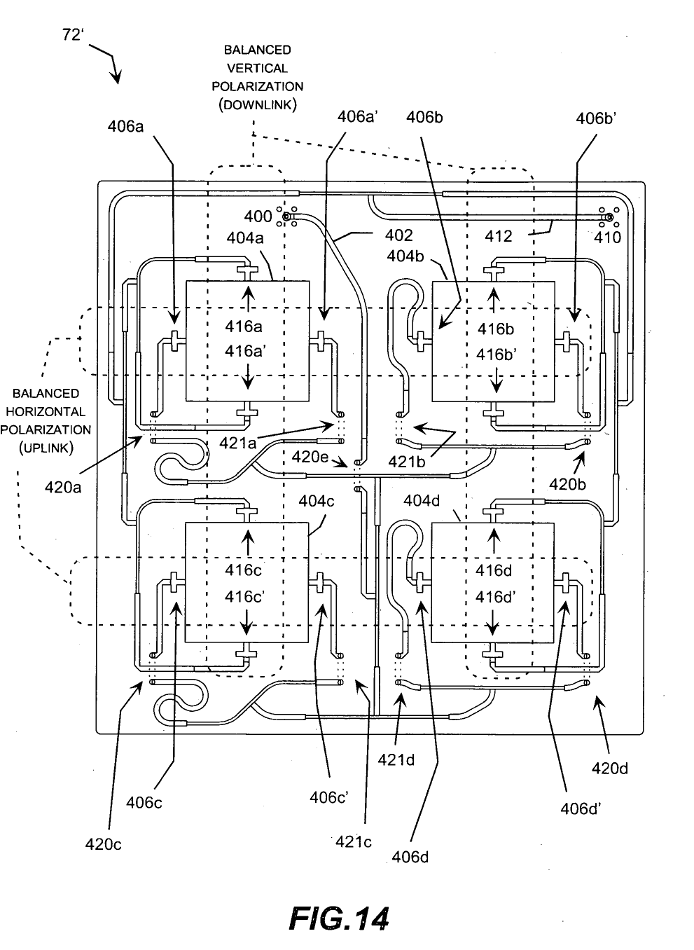

FIG. 3 is a conceptual illustration of the layered arrangement of the wireless repeater 10. Suppressing feedback avoids positive feedback between the server and donor antennas, which may be referred to as “ringing” and is similar in principle to the feedback instability experienced in an audio system when the microphone is place too close to a speaker. In general, narrower antenna beams, lower sidelobe energy, sharper polarization, and more precise frequency band definition reduce the tendency toward positive feedback. Balanced antenna feeds produce lower cross-polarization energy, which improves the server-donor antenna isolation but can be more expensive to implement than unbalanced antenna feeds. This is particularly true when using dual-polarization antenna elements implemented with microstrip technology, as described in greater detail with reference to FIGS. 11-14. It is therefore advantageous to use balanced and unbalanced antenna feed configurations in a strategic manner to meet the performance requirements of a particular application without incurring unnecessary costs. In addition, two antenna elements can be arranged in a quasi-balanced configuration, in which the antenna elements are positioned with proximal ends adjacent to each other, and unbalanced antenna feeds are located on distal ends of the antenna elements located away from and opposing the proximal ends. In other words, the unbalanced feeds are deployed in a mirror-image configuration, as shown in FIGS. 11-12 and described in greater detail with reference to these figures. In the alternative embodiment shown in FIGS. 13 and 14, all of the antenna elements have balanced feeds for both polarizations of a dual-polarization radiating element.

A preferred embodiment shown in FIG. 3 includes a combination of the balanced and quasi-balanced antenna feed configurations, which is particularly advantageous when using dual-polarization antenna elements implemented with microstrip technology. Specifically, the downlink signal path includes dual-polarization antenna elements with balanced feeds, whereas the uplink signal path includes dual-polarization antenna elements arranged in a quasi-balanced configuration. That is, the downlink portion 14 of the server antenna 12 and the downlink portion 22 of the donor antenna 20 include dual-polarization antenna elements with balanced feeds, whereas the uplink portion 16 of the server antenna 12 and the uplink portion 24 of the donor antenna 20 include dual-polarization antenna elements arranged in a quasi-balanced configuration. This configuration is described in detail for a particular embodiment using dual-polarization antenna elements implemented with microstrip technology with reference to FIGS. 11-12.

The layered structure of the wireless repeater 10 is also shown in FIG. 3 with descriptive labels and reference numerals included from the server side (left in FIG. 3) to the donor side (right in FIG. 3). These layers include a server radome 58, the server parasitic antenna elements 60, a server foam spacer 62, a server antenna feed circuit board 64 (which carries a microstrip server antenna feed circuit and driven antenna elements) a server mounting plate 66, a duplex repeater electronics board 68 (in this configuration, the entire BDA is implemented on the single electronics board 68), a donor mounting plate 70, a donor antenna feed circuit board 72 (which carries a microstrip donor antenna feed circuit and driven antenna elements), a donor foam spacer 74, donor parasitic antenna elements 76, and a donor radome 78. The server radome 58 covers and protects the server antenna elements 60 and also presents an aesthetically pleasing appearance in view of the fact that this side of the unit faces into the structure, usually a customer's premises, where it may be visible as mounted in its operational position. Similarly, the donor radome 78 covers and protects the donor antenna elements 76 and has a plain appearance suitable for the back side of the unit.

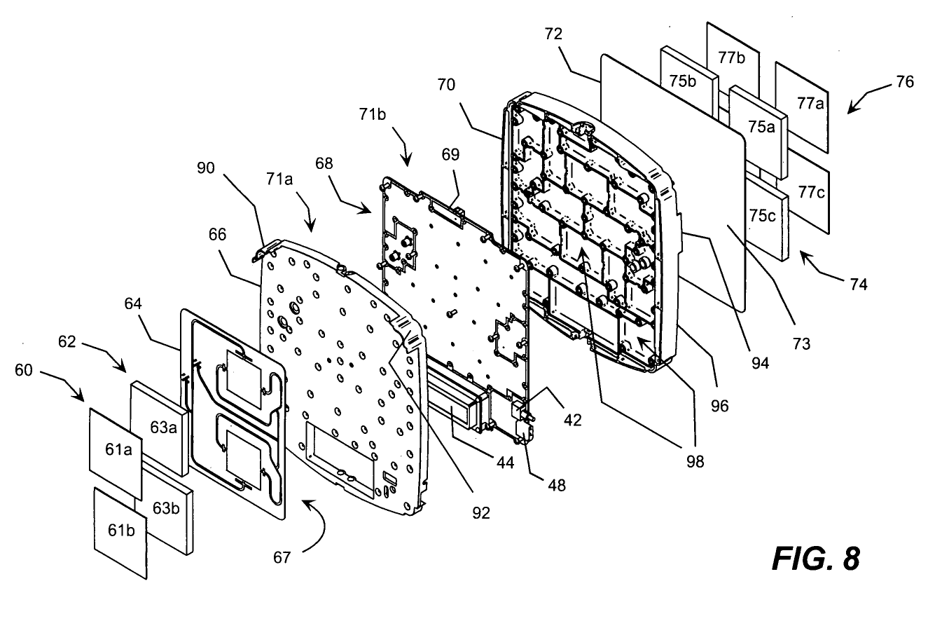

The server foam spacer 62 imparts a small spacing between the server antenna elements 60 and the server antenna feed circuit board 64, which couples these components to each other. The coupled arrangement of a driven microstrip patch radiating element and a parasitic patch radiating element serves to increase the operational bandwidth of the antenna radiating element. Both the driven microstrip patch element and the parasitic patch element radiate electromagnetic energy. More conventional patch antenna elements, without a foam spacer 62 between the server parasitic antenna element 60 (items 61a-b shown on FIG. 8) and the antenna patch feed traces (items 65a-b shown on FIG. 8) on the underlying antenna feed circuit board 64, are also a viable option. This is also applicable to the radiating donor antenna elements 76, donor foam spacer 74, and underlying donor antenna feed circuit board 72, which have a similar configuration.

The server antenna elements 60 and server foam spacer 62 are attached to the server antenna feed circuit board 64 with layers of an appropriate adhesive, which also imparts a small a dielectric effect. This composite structure is mounted to one side of a multi-purpose server mounting plate 76. The BDA 30 is implemented on a duplex repeater electronics board 68, which is attached to the opposing side of the server mounting plate. In a similar manner, a donor mounting plate 70 is attached to the opposing side of the duplex repeater electronics board, and a donor antenna feed circuit board 72 is mounted to the donor mounting plate, which in turn supports a donor foam spacer 74 and the donor antenna elements 76. The donor radome 78 then covers the donor side of the wireless repeater unit.

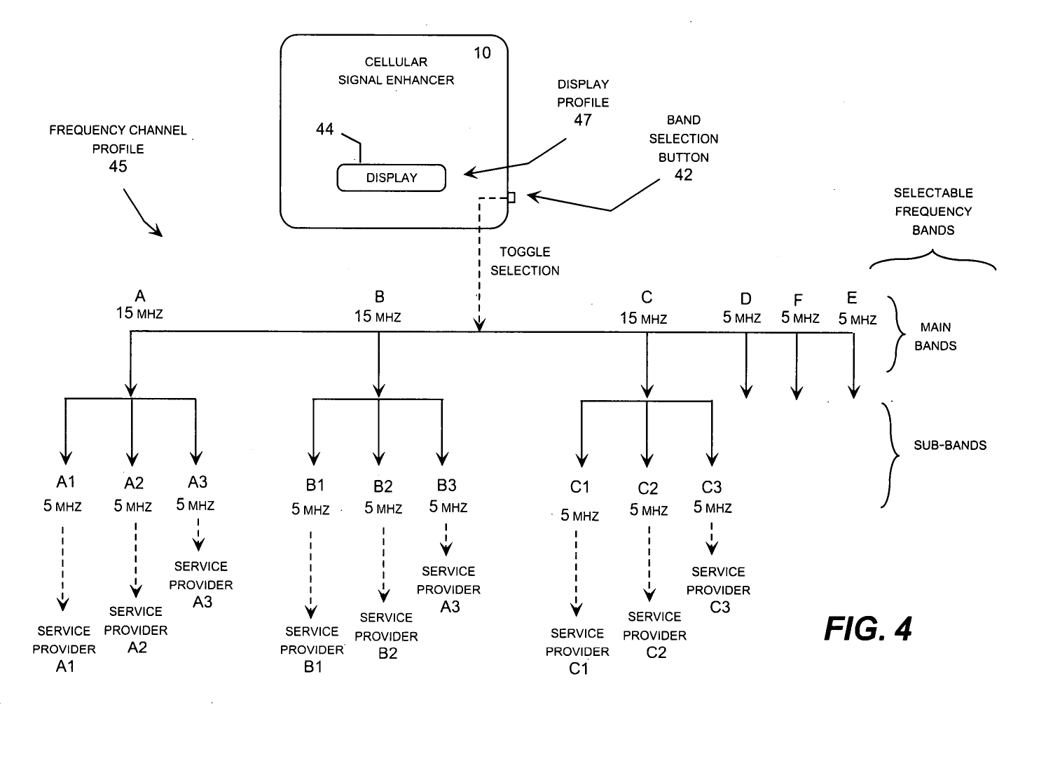

FIG. 4 is a conceptual illustration of a band selection and associated display feature for the wireless repeater 10. The band selection button 42 allows the user to toggle through the selectable channels of a frequency channel profile that typically includes a number of frequency bands and sub-bands within the frequency range of the wireless repeater. The display 44 shows a frequency band indicator corresponding to the frequency band selected with the button 42. The set of available frequencies or channels is referred to as the frequency channel profile 45, and the associated set of indicators shown on the display is referred to as the display profile 47. As described in greater detail with reference to FIG. 6, both the frequency channel profile 45 and the display profile 47 can be reconfigured after unit has been installed in the customer's premises by functionally accessing the unit's controller via the wireless transmitter/receiver 46 or the USB port 48, which are both shown on FIG. 2A.

In this particular example, the frequency channel profile 45 of the wireless repeater corresponds to the current state of the major frequency bands in the U.S. allocated to wireless telephone service including the US cellular frequency band between 824 MHz and 894 MHz and the UMTS band that encompasses the PCS-1900 and GSM-1800 digital system carrier frequency bands of 1710 MHz through 2170 MHz. To accommodate competition among multiple carriers, these major frequency bands are broken down into sub-band segments and 15 MHz main bands are the largest segment in the case of the US PCS-1900 system that can be assigned to assigned to a different licensed service provider or carrier. In some portions of the frequency range, the spectrum is broken down into 15 MHz main bands, which are further subdivided into 5 MHz sub-band, as shown in FIG. 4. This particular frequency channel profile 45 is suitable as the initial configuration of the unit, as set at the factory, for a wireless repeater intended for use in the United States. A different initial configuration will be appropriate for wireless repeaters intended for use in Europe or other foreign countries. Of course, the ability to reconfigure the frequency channel profile 45 and the display profile 47 after the unit has been installed in the customer's premises reduces the importance of the factor settings applied to the unit.

In this example, the frequency band indicators are simple, alphanumeric codes selected for convenient display and easy user comprehension. As shown in FIG. 4, each frequency band is represented by a frequency band indicator including a letter representing a main band and, and some cases, a number representing a sub-band. For example, the main bands are designated as “A”, “B”, “C” etc., with the sub-bands under main band “A” represented by A1”, “A2”, “A3” and so forth. This convenient frequency band indicator scheme is shown on the display 44 in coordination with operation of the band selection button 42, and the user looks up the corresponding carriers in a printed or on-line correlation table. In this manner, the user adjusts his or her the wireless repeater to operate for his or her selected carrier. However, full names or abbreviations of the carriers can alternatively be shown on the display. Alternatively, the band adjustment may be accomplished remotely by wired or wired connection by the action of a third party or by a computer.

FIG. 5 is a relatively simple functional block diagram of the wireless repeater 10. As noted previously with reference to FIG. 1, the wireless repeater unit 10 includes a server antenna 12, a donor antenna 20, and a BDA 30. The BDA 30 includes a downlink circuit 32 that includes a downlink amplifier circuit 31 and a downlink feedback cancellation circuit 33. The BDA 30 also includes an uplink circuit 34 that includes an uplink amplifier circuit 35, and an uplink feedback cancellation circuit 37. The uplink and downlink feedback cancellation circuits reduce amplitude and phase variations within the operating downlink and uplink frequency bands and increase the overall gain stability of the corresponding circuits, as is well known in the art of antenna engineering.

The amplitude variations resulting from a feedback signal having a time delay are different from the main signal in that feedback signals include characteristic ripples and the period and amplitude of the ripples in the passband response are generally functions of the relative time delays and the relative amplitudes of the primary and feedback signals. The predominate signal feedback path is external of the assembly of the server mounting plate 66, the duplex repeater electronics board 68, and the donor mounting plate 70. In other words, the feedback cancellation circuits 33 and 37 are internal to the assembly and provide signals that are aligned to cancel the external feedback signals.

The BDA 30 further includes a controller 50, which controls the operation of the unit including channel selection, amplifier gain settings, settings of the feedback cancellation circuits (phase, gain and/or delay), the functionality of the band selector button 42, and the functionality of the display 44. As described further below with reference to FIG. 6, the wireless unit also includes communication ports, including a wireless transmitter/receiver 46 and USB port 48, that can be used to reconfigure and control operational settings of the wireless repeater 10 through communication with the controller 50.

FIG. 5 also illustrates the basic control paradigm of the wireless repeater 10. The controller 50 can be accessed for control and reconfiguration purposes via communication ports, in this example the wireless transmitter/receiver 46 and the USB port 48. Once the unit has been configured with an appropriate frequency channel profile 45 and display profile 47, the user can select a desired frequency channel by toggling the band selection button 44. A particular frequency channel is determined by a center frequency and a bandwidth. The electronics for the amplifier and feedback cancellation circuits are operate at a fixed intermediate frequency (IF) of 315 MHz, which is more suitable to electronics than the RF frequencies used for wireless communications. The center frequency of the channel to which the unit is tuned is set by two local oscillators, one for the uplink circuit and a second for the downlink circuit. The bandwidth of the channel is selected by controlling switches for different bandpass filters having different bandwidths.

More specifically, the output of the local oscillator for the uplink or downlink circuit is mixed with the higher-frequency RF communication signals, with the IF frequency being the difference between the RF frequency and the frequency generated by the local oscillator. The frequency setting of the local oscillator therefore determines the center frequency of the RF that appears in the IF frequency of the electronics. The bandwidth of the channel is typically set by switching among bandpass filters having different bandwidths, such as 5 MHz and 15 MHz bandpass filters. The microprocessor 50 determines the center frequency by adjusting the setting of the local oscillator, and it determines the bandwidth of the channel by controlling the bandpass filter selection switches. The microprocessor 50 also controls the power level (gain settings) and the on-off status of the amplifiers in the downlink and uplink amplifier circuit 31 and 35. The microprocessor 50 also controls the settings of the downlink and uplink feedback cancellation circuit 33 and 37, typically the phase, gain and/or delay settings. These electronic control techniques, which are sufficient to implement the functionality described for the wireless repeater 10, are well known and specific circuitry for implementing the functionality is a mater of design choice.

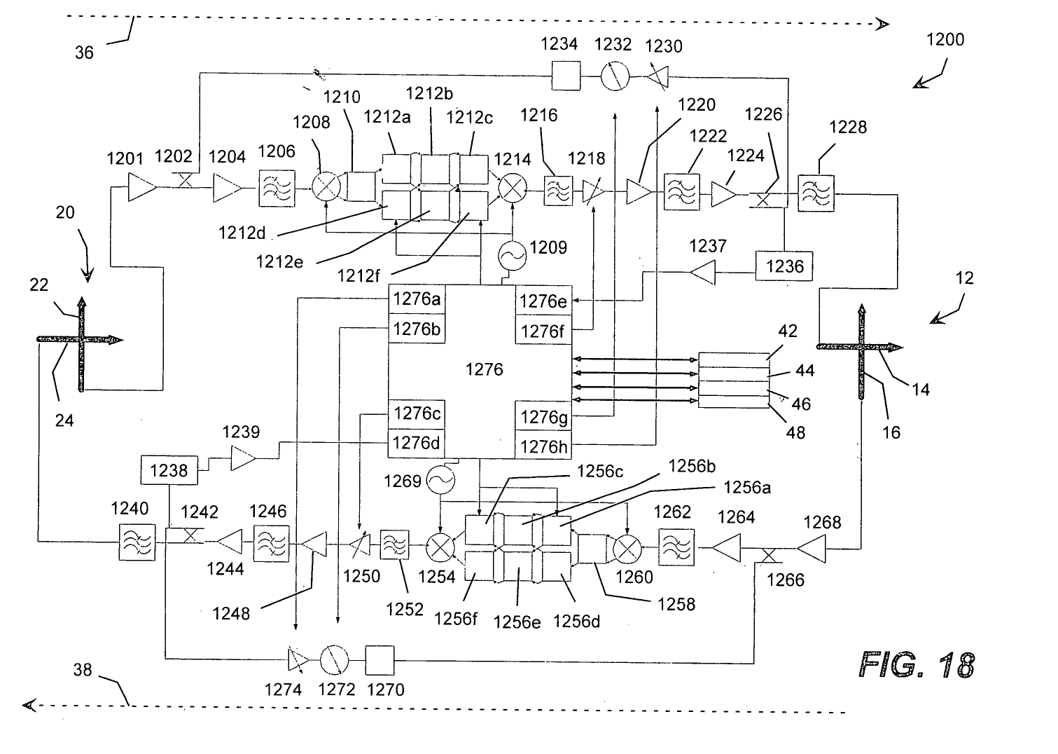

Typically, the wireless repeater 10 includes two local oscillators and two sets of bandpass filters and associated selection switches, one for the downlink signal path and another for the uplink signal path. The bandpass filters can be implemented with surface acoustical wave (SAW) filters, although other types of bandpass filters may be used. Those skilled in the art will understand that the SAW filters can be implemented in balanced or unbalanced filter configurations, with the attendant trade offs of performance versus complexity and cost. The size and cost of SAW filters can be smaller than dielectric loaded ceramic filters and the frequency selection characteristics outside the passband can be superior accompanied by a significant size reduction. Of course, these specific features are design choices that can be changed if desired. FIG. 18 shows a detailed circuit diagram of a particular embodiment of the electronics board 68.

FIG. 6 is a conceptual illustration of the features of the wireless repeater 10 that allow it to be controlled and reconfigured after it has been installed in the customer's premises. The wireless repeater includes an addressable controller 80 that can be accessed for control and reconfiguration purposes via one or more communication ports, in this example the wireless transmitter/receiver 46 and the USB port 48. The wireless transmitter/receiver 46 allows the unit to be accessed by a wireless remote controller 82, such as a control center, Internet server, personal computer, wireless telephone, PDA, or other suitable device. In particular, the wireless transmitter/receiver 46 may be a wireless telephone chip with a dedicated directory number that the remote controller 82 accesses by placing a telephone call to the wireless repeater's directory number. This allows the wireless remote controller to send addressed commands signals 83 to, and receive return signals 84 from, the wireless repeater 10. In this way, the wireless repeater can be controlled and reconfigured from the wireless remote controller 82.

In general, wireless access enables a service technician or computer-based controller at the wireless remote controller 82 to control and reconfigure the wireless repeater without having to physically handle the unit. For example, the service technician can download the appropriate frequency channel profile 45 and the display profile 47 once the installed location of the unit has been determined. Although the installed location of the unit can be obtained from the customer, for example by asking the customer to provide his or her address and/or zip code, it can also be ascertained from the location of the base station that is in communication with the wireless transmitter/receiver 46. The remote control center may also implement more advanced calibration and programming functions to improve the feedback suppression and performance of the unit, such as adjusting the settings of the feedback cancellation circuits, and adjusting the uplink and downlink gain settings to enhance the wireless repeater service while avoiding positive feedback between the uplink and downlink circuits. As additional examples, the remote control center may change the power level or turn the unit on or off, which may be desirable when the carrier is servicing its own equipment. The remote control center may also download firmware upgrades, diagnostic modules, and new programming features that may become available in the future.

Some or all of this functionality can also be implemented by a wire-line remote controller by using a USB cable 86 to connect the USB port 18 on the wireless repeater 10 to a wired remote controller 85, such as a personal computer located in the customer's premises. For example, once the unit is connected to a personal computer using the USB port 18, it can be assigned an Internet IP address and accessed from a remote control location just like any other node on the Internet. In addition, a predefined set of simpler functions (e.g., initialization, frequency band selection, and gain adjustment) may be performed by the user using the USB port and an associated software program running on a personal computer, whereas more sophisticated functionality (e.g., downloading the appropriate frequency channel profile and display profile, setting the configurable parameters of the feedback cancellation circuit, and advanced troubleshooting) may be performed wirelessly by a remote control center. Of course, other configuration and programming paradigms may be implemented, such as allowing the user to tune the wireless repeater to the desired frequency band using a wireless telephone, having a remote control center download software files over the Internet to the user's computer, which the user then uses to upload the files to the wireless repeater using the USB port, and so forth.

Also, once the wireless repeater unit has been connected to a personal computer through the USB port, the unit can be assigned an Internet IP address and accessed as a network node, which allows the unit to be controlled and reconfigured from a remote location over the Internet. This allows the wireless unit to be controlled and reconfigured by a user working on the unit in the customer's premises, who may be assisted by printed, electronic or on-line instructions and help. Alternatively, the wireless unit can be controlled and reconfigured from a remote location by a service technician or by a computer-based controller. Both control and reconfiguration modes are useful, and some users may be more willing to learn to operate and configure their units while others may prefer to have a service technician or computer-based controller handle the task. In either case, the ability to control and reconfigure the wireless repeater after it has been installed in the customer's premises produces a number of important advantages.

For example, the ability to change the frequency channel profile for the unit is a major advantage that allows the same wireless repeater to be deployed in any region in the world. The ability to change the display indicator profile complements the reconfigurable frequency channel profile by allowing the unit to display shorthand indications of the names of the carriers that are actually available in the location where the unit is installed. As one option, the display can be configured to show simple alpha-numeric codes as frequency band indicators, each corresponding to a particular frequency band, to assist in the selection of the desired one. Each band indicator includes a letter representing a main band and, and some cases, a number representing a sub-band. For example, the main bands may be “A”, “B”, “C” etc., with the sub-bands under main band “A” represented by A1”, “A2”, “A3” and so forth. The frequency band indicator is shown on the display and the user looks up the associated carriers in a printed or on-line correlation table. Of course, any other suitable system of frequency band indicators, such as shorthand carrier names or abbreviations, could be used. In addition, the preferred display is an inexpensive LED matrix, but any other suitable type of display may be used.

As another example, the display may show shorthand indicators identifying the various service providers or carriers, such as “T-Mobile,” “Cingular,” “Verizon,” “Sprint” and so forth. Typically, the unit will be come from the factory with an initial channel profile and display profile. The unit will also come with configuration software operable to run on a personal computer, which may be included on a CD or made available on-line and accessible via the Internet. Because the correct frequency channel profile and display profile is a function of the location of the unit, this information can be easily correlated to the customer's address and/or zip code or, in the case of a foreign country, the identification of the correct country. Also, once the wireless transmitter/receiver in the unit has been activated, the location of the unit can be ascertained from the location of the base station that communicates with the unit and using location technology as applied to a mobile telephone. The presence of the transmitter/receiver in the unit and unique telephone number makes the unit potentially cable of many of the same functions available in the mobile telephone.

The ability to change the feedback circuit parameters provides a cost effective way to hone the feedback cancellation circuit, and thereby improve the feedback suppression and available gain of the unit, based on the manner and specific location in which the unit has been installed. In particular, different feedback circuit parameters are desirable when the unit is positioned against or very close to a glass window, versus when it is at least four inches (ten centimeters) away. Similarly, different feedback circuit parameters are desirable when the unit is located towards the interior of a building, such as a location above the ceiling tiles near the center of an office, as opposed to in or close to a widow. The installation conditions can be obtained by having the customer enter the data into the configuration software running on a personal computer connected to the wireless unit. Alternatively, the customer can be prompted to contact a service technician or computer-based controller using the telephone or over the Internet. The technician or computer-based controller can then question the customer and use the information obtained to configure the wireless repeater from a remote location.

Another advantage is derived from having the ability to adjust the power level and to turn the wireless repeater on or off from a remote location. This feature is helpful to the carrier, which may have a need to lower or turn the power of the units off when servicing its own equipment. The carrier might also benefit in some instances from having the ability to adjust the power of certain wireless repeater units in responses to changes in its system, such as the upgrade or activation of a new base station. It is also helpful for the carrier or a service technician to have the ability to adjust the power level (gain) along with the feedback circuit parameters to test the operation of the wireless repeater in various potential installation locations, and the optimize the settings of the unit once it has been installed in a permanent location. The ability to set the frequency channel from a remote location will also be useful in some instances, for example when configuring the units in a commercial location prior to occupancy and when assisting those end-users who are simply unable or unwilling to figure out how to set the channel themselves. The ability to download firmware updates and other program files will also be a big advantage for maintaining, upgrading and troubleshooting the units after they have been installed.

Remote access for controlling and reconfiguring the wireless unit can be implemented with an on-board wireless telephone chip or chipset. For this option, the on-board controller is addressable through a dedicated directory number assigned to the wireless telephone chip in the unit. The controller may also be accessed with a wire-line connection through an on-board USB port. Obviously, any other suitable type of wireless or wire-line interface may be used. This allows the wireless repeater to be accessed by a local device, such as a personal computer, a conventional wire-line telephone, a wireless telephone, PDA, or other suitable device located in the same premises with the wireless repeater. Additional access schemes may also be used communicate with the wireless repeater wirelessly, for example from a control center operated by the user's carrier, the manufacturer of the wireless repeater, or another authorized party. In this way, the remote controller can perform a wide range of increasingly sophisticated operations on the wireless repeater ranging from simple activation, initialization and tuning of the device to the desired channel, as well as more advanced operations including changing the frequency channel profile, changing the display profile, configuring the feedback cancellation circuits, and any other operation such as interrogating, reprogramming, troubleshooting, upgrading, and so forth. The remote controller may also adjust the uplink and downlink gain to enhance the wireless repeater service while avoiding positive feedback between the uplink and downlink circuits.

In general, the combination of local and remote configuration modes, along with a rich set of reconfigurable parameters, provides a wide range of flexibility that allows both end-users and professional service technicians to customize and optimize the settings of the unit. In many cases, provisioning the wireless repeater unit to be reconfigured in field after it has been installed in the customer's premises is a lower cost and more effective alternative than attempting to make the unit automatically optimize its own settings, for example with adaptive feedback circuits and sophisticated gain control algorithms.

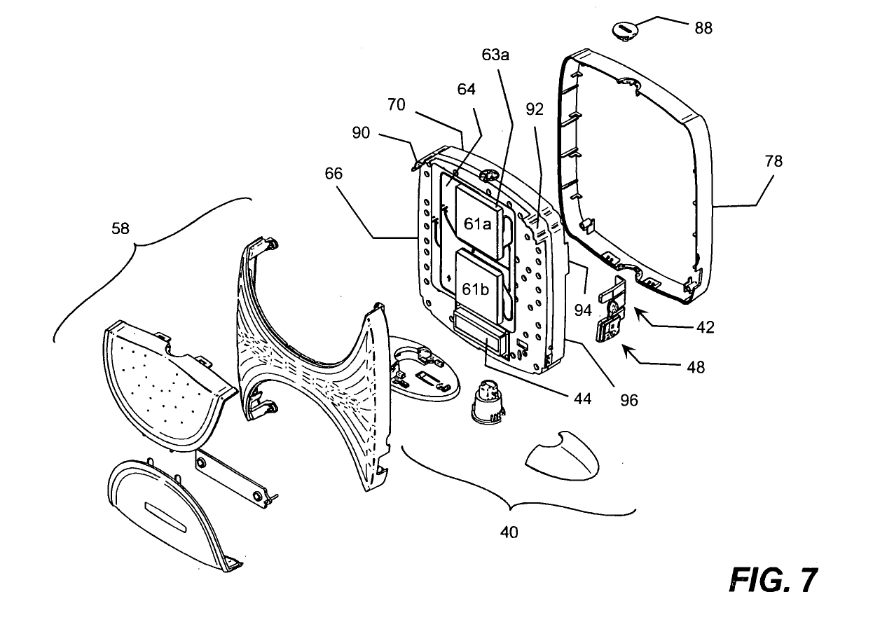

FIGS. 7-11 show a particular embodiment of the wireless repeater 10 approximately to scale with the maximum horizontal dimension of the device approximately equal to 8.4 inches [21.3 cm]. FIG. 7 is a partially exploded view of the server side of a particular embodiment of the wireless repeater 10. This view shows that the server radome 58 is composed of three separate plastic components, as is the pedestal 40. In this particular example, the pedestal is received in a lower receptacle and a plug 88 is used to cover the upper receptacle. FIG. 7 also shows a number of mechanical features that improve the server-donor antenna isolation to reduce positive feedback between the antenna and donor antennas. These features include corner tabs 90 and 92 on the server-facing side of the server mounting plate 66, and side tabs(s) 94 (only one side tab is shown in FIG. 2) and a side walls 96 around the donor-facing side of the donor mounting plate 40. Note that the corner and side tabs are asymmetrical, which has been found to be effective for server-donor antenna isolation. The particular sizes and locations of these components have been determined through computer modeling and prototype testing to produce the effectual improvements in server-donor antenna isolation.

In addition, FIG. 7 shows that the server antenna is an array comprised of two dual-polarization radiating elements 61a and 61b arranged in an over-under configuration that produces a wider coverage pattern beam width in the horizontal plane than in the vertical plane. The ratio of beam width in the horizontal plane to the beam width in the vertical plane is approximately 1:2, which may be referred to as a type of fan-beam pattern. FIG. 8 shows a donor antenna array comprised of four dual-polarization radiating elements 77a, 77b, 77c, and 77d arranged in a substantially square configuration that produces a substantially symmetrical coverage pattern in the horizontal plane and vertical planes. Therefore, the ratio of beam width in the horizontal plane to the beam width in the vertical plane is approximately unity, which may be referred to as a type of pencil-beam pattern. The fan-beam pattern characteristic is preferred for a server coverage area as it is desirable to illuminate a wide area inside the structure 51. It is also preferable to use two radiating elements 61a and 61b to achieve a greater antenna gain value than can be achieved with a single radiating element, and the over-under configuration is preferred to maintain a wide area coverage within a single floor the structure 51. It is also preferable to use four radiating elements 77a, 77b, 77c, and 77d to achieve a greater antenna gain value on the donor side and to improve the isolation of signals by directivity of the four-element antenna array. A repeater 10 is often necessary in non-line-of-sight (NLOS) conditions of the structure 51 and the base station 26. NLOS conditions can make the allow the donor antenna to be less important than LOS conditions and often the height of the repeater 10 above the local terrain is likely to produce greater signal change than pointing in the horizontal plane. Of course, it is still advantageous to position and point the unit favorably in view of the configuration of the structure where the unit is located, the direction and distance to the base station 26, and the signal propagation conditions.

FIG. 8 shows the electrical grounding elements in the sandwich repeater assembly 10 illustrated in FIG. 3. The server feed circuit board 64 includes a conducting ground layer 67 on the bottom surface of the printed circuit board 64. This conducting ground plane 67 is a copper material that has a final finish of electroplated Tin to avoid oxidation normally occurring with Copper. The server mounting plate 66 is an injection molded part of a plating grade of Acrylonitrile Butadiene Styrene (ABS) plastic that has a Copper layer in direct contact with the ABS and an outer layer of Nickel. The copper layer provides the highest conductivity of the two plated metal layers and the outer Nickel layer provides a suitable final finish that is relatively inactive in the production of oxides over time in the use environment. The Nickel layer of the server mounting plate 66 is in direct electrical contact with the ground layer 67 of the server feed circuit board 64.

The donor feed circuit board 72 includes a conducting ground layer 73 on the bottom surface of the printed circuit board 72. The material and finish is the same as the server feed circuit board 64. The materials and finish of the donor mounting plate 70 is the same as the server mounting plate 66 and the outer Nickel layer is in direct contact with ground layer 73. In other words there is electrical bonding of the feed circuit boards 64 and 72 with the mounting plates 66 and 70. Furthermore, when mounting plates 66 and 70 are attached together with many screw fasteners (omitted for clarity) there is a very complete and robust electrical connection between the mounting plates 66 and 70 and feed circuit boards 64 and 72 as a unit. In addition, circuit board 68 includes a conductive ground trace 69 that runs around the perimeter of the board. A first conductive gasket 71a is placed between the server mounting plate 66 and the circuit board 68, and a similar conductive gasket 71b is placed between the circuit board 68 and the donor mounting plate 70. This creates a complete and robust electrically grounded enclosure surrounding the circuit board 68 and separating the server and donor antenna feed circuit from each other, both physically and electrically. Moreover, the server and donor antenna elements 60, 76 are parasitically coupled to their underlying antenna feed circuits, providing an additional level of electrical isolation and noise suppression.

As a result, the duplex repeater electronics board 68 is effectively encapsulated within a electrically uniform DC-grounded housing in the sandwich assembly between the server mounting plate 66 and the donor mounting plate 70. This configuration provides shielding effectiveness for the circuitry on the electronics board 68 and within this shield are individual shielded spaces 98 for individual circuits of the electronics board 68. The shielded spaces or zones 98 are provided in both the server mounting plate 66 and the donor mounting plate 70 for the double-sided electronics board 68.

The ridges surrounding the isolation zones 98 have a conductive gasket bead run continuously along each ridge including the ridges along the perimeter of the mounting plates 66 and 70. This conducting gasket bead is compressible and provides for a continuous electrical bond between the double-sided electronics board 68 and the plates 66 and 70. The double-sided electronics board 68 has corresponding ground signal conducting strips 69 along the top and bottom surfaces of the board that match the ridges on the plates 66 and 70. Many strips 69 on the electronics board 68 have been omitted for clarity and a few interior examples are shown along with the full perimeter strip 69. The perimeter strip 69 also separates the display 44 by providing a boundary around the perimeter adjacent to the circuitry on the electronics board 68. After assembly, the isolation zones 98 define a number of cavities formed by mounting plates 66 and 70 and the electronics board 68 that isolate different portions of the electronics circuit.

FIGS. 8-9 and 11 also show that for this particular embodiment, the server antenna elements 60 includes two square patch antenna elements 61a-b arranged in vertical alignment, which are supported by coextensive foam spacers 63a-b, respectively. In similar fashion, as shown in FIGS. 8, 10 and 12, the donor antenna elements 76 includes four square patch antenna elements 77a-d arranged in a square configuration, which are supported by coextensive foam spacers 75a-d, respectively. Of course, the type, shape, number and arrangement of the antenna elements and foam spacers (e.g., one foam spacer carrying multiple antenna elements) could all be altered in alternative embodiments. It should be noted that patch antenna elements and feed circuits have the desirable quality of being amenable to mass production using inexpensive etching techniques on sheets of PC board.

FIGS. 11-14 show specific embodiments of server and donor microstrip antenna feed circuits using dual-polarization antenna arrays. At this point, it will be helpful to establish the nomenclature for balanced, unbalanced and quasi-balanced antenna feed configurations. The use of two opposing element feeds located on opposite sides of an antenna element is referred to as a balanced feed configuration, whereas the use of a single antenna feed located on one side of the antenna element is referred to as an unbalanced feed. In addition, two antenna elements can be arranged in a quasi-balanced configuration, in which the antenna elements are positioned with proximal ends adjacent to each other, and unbalanced antenna feeds are located on distal ends of the antenna elements located away from and opposing the proximal ends.

The use of balanced antenna feeds results in a more sharply polarized beam with lower cross-polarization energy, whereas unbalanced antenna feeds are typically less complex and costly to implement. When using microstrip technology, in particular, implementing balanced antenna feed arrangements for both the uplink and the downlink portions of dual-polarization antenna elements requires crossovers in the microstrip antenna feed circuit. A server antenna feed circuit 64′ with this configuration is shown in FIG. 13 and a donor antenna feed circuit 72′ with this configuration is shown in FIG. 14. Including balanced and quasi-balanced antenna feeds, on the other hand, achieves somewhat sharpened polarization without the need for crossover in the antenna feed circuit. A server antenna feed circuit 64 with this configuration is shown in FIG. 11 and a donor antenna feed circuit 72 with this configuration is shown in FIG. 14. The trade-off between these alternatives is illustrated for the server antenna by comparing FIG. 11 with FIG. 13, and for the donor antenna by comparing FIG. 12 with FIG. 14.

It should therefore be appreciated that the use of a combination of balanced and unbalanced feed arrangements in dual polarization antenna elements in the quasi-balanced antenna feed arrangement shown in FIGS. 11 and 13 is an efficient way to implement dual cross-polarization isolation with dual-polarization microstrip antenna elements without the need for crossovers in the antenna feed circuits. More specifically, the present invention recognizes that the signal polarization can be sharpened through the use of antennal elements with balanced feeds, as shown and described with reference to FIGS. 11-14 of the present application. Sharpening the polarization improves the feedback suppression performance of the dual cross-polarization isolation techniques. However, implementing balanced feeds incurs the additional expense of two, rather then just one, antenna feed element per antenna element for each polarization that is balanced-fed. This cost is relatively low when only a single polarization of the dual-polarization parch antenna element includes balanced feeds, as shown in FIGS. 11-12, because this configuration can be implemented without crossovers in the signal traces. Implementing balanced feeds for both polarizations, however, requires crossovers in the signal traces.

On a PC board, the need for crossovers presents a design challenge because the signal traces must remain physically separated from each other to avoid electrical interconnection (if the signal traces physically touch each other) or radiating interference or cross-talk (if the signal traces come too close together without physically touching each other). A number of techniques have been developed to implement signal trace crossovers on PC boards, such as “flying bridge” sections of PC board that physically jump one signal trace segment over another, coaxial cable links to cross each other, and multiple layered PC board constructs with conductors suspended in air and extending between PC boards to implement crossovers. Each of these designs increases the cost of the circuit, reduces the physical ruggedness of the circuit, and has the potential to increase noise generation and RF signal loss, particularly at junctions between different types of transmission media segments. More importantly, these somewhat clumsy solutions to the crossover problem greatly complicate the manufacturing process because the entire circuit cannot be arranged on a single PC board using stripline transmission media segments formed into the PC board that can then be manufactured through a conventional etching techniques and processes.

Another crossover technique employs a circuit known as a “zero-dB crossover” that can be comprised of two cascaded quadrature hybrid junctions. Although this type of crossover can be implemented on a single flat PC board without physical trace jumps, it occupies a relatively large section of PC board space. However, in a compact wireless repeater, PC board space is at a premium. For these reasons, the embodiments of the present invention implement crossovers with pin-type connectors tapped through the PC board and short signal trace segments carried on the opposite side of the PC board from the main RF circuit. Although this is an elegant solution, the need to print portions of the RF signal trace circuit on both sides of the PC board represents a significant additional expense. Accordingly, the use of dual-polarization antenna elements with balanced feeds for both polarizations, as shown in FIGS. 13-14, is one particular embodiment of the invention.

It should also be understood that the invention may alternatively be implemented with dual-polarization antenna elements having balanced feeds for one polarization and unbalanced feeds for the other polarizations, as shown in FIGS. 11-12. This configuration has the trade-off advantages of sharpened, balanced fed-polarization for one polarization, while avoiding the additional expense of crossovers required to implement balanced feeds for both polarizations. To provide partially sharpened polarization for the unbalanced polarization, the unbalanced feeds are deployed in a quasi-balanced two-element array configuration in which the antenna elements are positioned with proximal ends adjacent to each other, and unbalanced antenna feeds are located on distal ends of the antenna elements located away from and opposing the proximal ends. In other words, the unbalanced feeds are deployed in a mirror-image configuration, as shown in FIGS. 11-12. Of course, it is evident that one or more of the dual-polarization antenna elements could be replaced by two single-polarization antenna elements serving the same functions. Although this configuration would double the number of antenna elements, this technique can be use to implement balanced antenna feeds for both polarizations without the need for crossovers, and the present invention contemplates such a configuration.

Thus, it should be appreciated that the wireless repeater can include dual-polarization server and donor antennas with balanced and quasi-balanced feed circuits to improve server-donor feedback suppression. Balanced feed circuits produce sharpened polarization, which may also be described as improved polarization purity. This technique improves the feedback suppression of the repeater, but when implemented for both polarizations of dual-polarization antenna elements, requires the tradeoff of, signal trace crossovers. These crossovers are problematic when the antenna feed circuit is implemented on a microstrip PC board. Quasi-balanced feed circuits, on the other hand, provide partially sharpened feedback suppression without requiring signal trace crossovers, which is an important advantage when the antenna feed circuit is implemented on a microstrip PC board. A preferred configuration therefore includes dual-polarization antenna elements with balanced feed circuits for one polarization and quasi-balanced feed element for the other polarization. Both approaches (i.e., dual-polarization antennas with balanced feed circuits for both polarizations, and those with combination of balanced and quasi-balanced antenna feed circuits) result in sharpened polarization and improved feedback suppression. These techniques are well suited to improving feedback suppression in wireless repeaters implementing dual cross-polarization isolation with dual-polarization antenna elements.

FIG. 11 is a front view of a particular embodiment of the server antenna feed circuit board 64 for the wireless repeater 10. In this particular embodiment, the server antenna is a two-element array of dual-polarization, microstrip patch antenna elements 104a and 104b in which both antenna elements include uplink and downlink portions. For the server downlink circuit, the server antenna feed circuit includes a server downlink port 100, which connects to a server downlink circuit trace 102. The server downlink circuit trace 102, in turn, connects to an upper server patch antenna element 104a at two horizontally oriented, opposing element feeds 106a and 106a′. The downlink feed trace 102 also connects to a lower server patch antenna element 104b at two horizontally oriented, opposing element feeds 106b and 106b′. For the server uplink circuit, the server antenna feed circuit includes a server uplink port 110, which connects to a server uplink circuit trace 112. The server uplink circuit trace 112, in turn, connects to the upper server patch antenna element 104a at a single, vertically-oriented, downward facing element feed 116a. The uplink server feed trace 112 also connects to the lower server patch antenna element 104b at a single, vertically-oriented, upward facing element feed 116b.

For example, the two horizontally oriented, opposing element feeds 106a and 106a′ form a balanced, horizontal polarization feed arrangement for the upper server antenna element 104a. In addition, the single vertically-oriented, downward facing element feed 116a forms an unbalanced, vertical polarization feed arrangement for the upper server antenna element 104a. Thus, the upper server antenna element 104a is a dual-polarization antenna element that includes a combination of a balanced and unbalanced antenna feed arrangements. Specifically, the downlink portion of the antenna element 104a includes a balanced, horizontal polarization feed arrangement implemented by the horizontally oriented, opposing element feeds 106a b and 106a′. In addition, the uplink portion of the antenna element 104a includes an unbalanced, vertical polarization feed arrangement implemented by the antenna feed 116a. The same can be said for the lower server antenna element 104b. That is, the downlink portion of the lower server antenna element 104b includes a balanced, horizontal polarization feed arrangement implemented by the horizontally oriented, opposing element feeds 106b and 106b′. And the uplink portion of the lower server antenna element 104b includes an unbalanced, vertical polarization feed arrangement implemented by the antenna feed 116b. In addition, the unbalanced feeds 116a and 116b form a two-element, quasi-balanced antenna feed configuration.

FIG. 12 is a front view of a particular embodiment of the donor antenna feed circuit board 72 for the wireless repeater 10. Like the server antenna feed circuit shown in FIG. 11, this particular donor antenna feed circuit includes dual-polarization, microstrip patch dual-polarization antenna elements and a combination of balanced and quasi-balanced antenna feed configurations, which allows the feed circuit to be implemented without crossovers. FIG. 14 shows an alternative donor antenna feed circuit board 72′ in which all of the antenna feeds are balanced. Again, the trade-off between the use of quasi-balanced feeds versus crossovers is illustrated for the donor antenna by comparing FIG. 12 with FIG. 14.

For the donor uplink circuit, the donor antenna feed circuit 72 includes a donor uplink port 200, which connects to a donor uplink circuit trace 202. The donor uplink circuit trace 202, in turn, connects to an upper-left donor antenna element 204a at a horizontally oriented element feed 206a. Similarly, the donor uplink circuit trace 202 connects to an upper-right donor antenna element 204b at a horizontally oriented element feed 206b. The donor uplink circuit trace 202 also connects to a lower-left donor antenna element 204c at a horizontally oriented element feed 206c. Similarly, the donor uplink circuit trace 202 connects to a lower-right donor antenna element 204d at a horizontally oriented element feed 206d.

For the donor downlink circuit, the donor antenna feed circuit 72 includes a donor downlink port 210, which connects to a donor downlink circuit trace 212. The donor downlink circuit trace 212, in turn, connects to the upper-left donor antenna element 204a at two opposing, vertically oriented element feeds 216a and 216a′. Similarly, the donor downlink circuit trace 212 connects to the upper-right donor antenna element 204b at two opposing, vertically oriented element feeds 216b and 216b′. The donor downlink circuit trace 212 also connects to the lower-left donor antenna element 204c at two opposing, vertically oriented element feeds 216c and 216c′. Similarly, the donor downlink circuit trace 212 connects to the lower-right donor antenna element 204d at two opposing, vertically oriented element feeds 216d and 216d′.

FIG. 12 therefore shows that the downlink portion of the donor antenna includes a first balanced, vertical polarization antenna feed arrangement implemented by the opposing, vertically oriented antenna feeds 216a and 216a′ for the upper left antenna element 204a. A second balanced, vertical polarization antenna feed arrangement is implemented by the opposing, vertically oriented antenna feeds 216b and 216b′ for the upper right antenna element 204b. A third balanced, vertical polarization antenna feed arrangement is implemented by the opposing, vertically oriented antenna feeds 216c and 216c′ for the lower left antenna element 204c. And a fourth balanced, vertical polarization antenna feed arrangement is implemented by the opposing, vertically oriented antenna feeds and 216d and 216d′ for the lower right antenna element 204d.

In addition, the uplink portion of the donor antenna includes a first unbalanced, horizontal polarization antenna feed arrangement implemented by the horizontally oriented antenna feed 206a for the upper left antenna element 204a. A second unbalanced, horizontal polarization antenna feed arrangement is implemented by the horizontally oriented antenna feed 206b for the upper right antenna element 204b. A third unbalanced, horizontal polarization antenna feed arrangement is implemented by the horizontally oriented antenna feed 206c for the lower left antenna element 204c. And a fourth unbalanced, horizontal polarization antenna feed arrangement is implemented by the horizontally oriented antenna feed 206d for the lower right antenna element 204d. It should also be understood that the upper antenna elements 204a and 204b form a quasi-balanced feed arrangement implemented by the opposing, horizontally oriented antenna feeds 206a and 206b located on two adjacent antenna elements. Similarly, the lower antenna elements 204c and 204d form a quasi-balanced feed arrangement implemented by the opposing, horizontally oriented antenna feeds 206c and 206d located on two adjacent antenna elements.

FIG. 13 is a front view of a particular embodiment of the server antenna feed circuit 64′ for the wireless repeater 10. This particular embodiment includes a two-element array of dual-polarization, microstrip patch antenna elements with balanced feed arrangements for both the uplink and downlink portions of the antenna elements. This configuration therefore requires crossovers in the feed circuit. Specifically, the circuit includes one crossover for each antenna element. As noted previously, this additional complexity required to implement this server antenna alternative with balanced feed arrangements for both the uplink and downlink portions of the antenna elements is illustrated by comparing this embodiment with the server antenna feed circuit board 64 shown on FIG. 11.

For the downlink portion of the server antenna, the server feed circuit board 64′ includes a server downlink input port 300, which connects to a server downlink circuit trace 302. The server downlink circuit trace 302, in turn, connects to an upper server antenna element 304a at a pair of opposing, horizontally oriented element feeds 306a and 306a′. The downlink feed trace 102 also connects to a lower downlink patch antenna element 304b at a pair of opposing, horizontally oriented element feeds 306b and 306b′. The opposing, horizontally oriented element feeds 306a and 306a′ result in a balanced, horizontal polarization feed arrangement for the downlink portion of the upper server antenna element 304a; whereas the opposing, horizontally oriented element feeds 306b and 306b′ result in a balanced, horizontal polarization feed arrangement for the downlink portion of the lower server antenna element 304b.

For the server uplink circuit, the server antenna feed circuit includes a server uplink input port 310, which connects to a server uplink circuit trace 312. The server uplink circuit trace 312, in turn, connects to the upper server antenna element 304a at a pair of opposing, vertically-oriented element feeds 316a and 316a′. The uplink server feed trace 312 also connects to the lower server antenna element 304b at a pair of opposing, vertically-oriented element feeds 316b and 316b′. The opposing, vertically-oriented element feeds 316a and 316a′ result in a balanced, vertical polarization feed arrangement for the uplink portion of the upper server antenna element 304a; whereas the opposing, vertically-oriented element ports 316b and 316b′ results in a balanced, vertical polarization feed arrangement for the uplink portion of the lower server antenna element 304b.

The implementation of balanced antenna feeds for both the uplink and downlink circuits in this particular example requires the use of upper and lower crossovers 320a and 320b, where the downlink and uplink circuit traces 302 and 312 pass each other. In this particular example, the crossovers 320a and 320b are implemented by pin-type connectors through the circuit board and a short signal trace on the opposite side of the circuit board. The server feed circuit also includes a pair of phantom crossovers 321a and 321 b, which are implemented by pin-type connectors through the circuit board and a short signal trace on the opposite side of the circuit board in areas where the downlink and uplink circuit traces 302 and 312 do not pass each other. The phantom crossovers 321a and 321b mirror the actual crossovers 320a and 320b, and are included in the circuit to equalize the lengths of the circuit traces to the antenna feeds to ensure proper phase matching of the balanced antenna feeds.

FIG. 14 is a front view of a particular embodiment of the donor antenna feed circuit board 72′ for the wireless repeater 10. This particular embodiment includes a four-element array of dual-polarization, microstrip patch elements with balanced feed arrangements for both the uplink and downlink portions of the antenna elements. Like the server antenna feed circuit shown in FIG. 13, this configuration requires crossovers in the feed circuit. Specifically, this embodiment includes one crossover for each antenna element, plus an additional crossover between the upper and lower halves of the feed circuit. Again, this additional complexity required to implement balanced feed arrangements for both the uplink and downlink portions of the dual-polarization antenna elements is illustrated by comparing this embodiment with the donor antenna feed circuit board 72 shown on FIG. 12.

For the donor uplink circuit, the donor antenna feed circuit 72′ includes a donor uplink port 400, which connects to a donor uplink circuit trace 402. The donor uplink circuit trace 402, in turn, connects to an upper-left donor antenna element 404a at a pair of opposing, horizontally oriented element feeds 406a and 406a′. Similarly, the donor uplink circuit trace 402 also connects to an upper-right donor antenna element 404b at a pair of opposing, horizontally oriented element feeds 406b and 406b′. The opposing, horizontally oriented element feeds 406a and 406a′ result in balanced, horizontal polarization feed arrangement for the uplink portion of the upper-left donor patch antenna trace 404a; whereas the opposing, horizontally oriented element feeds 406b and 406b′ result in a balanced, horizontal polarization feed arrangement for the uplink portion of the upper-right donor patch antenna element 404b.

The donor uplink circuit trace 402 also connects to a lower-left donor patch antenna element 404c at a pair of opposing, horizontally oriented element feeds 406c and 406c′. Similarly, the donor uplink circuit trace 402 connects to a lower-right donor patch antenna element 404d at a pair of opposing, horizontally oriented element feeds 406d and 406d′. The opposing, horizontally oriented element feeds 406c and 406c′ result in a balanced, horizontal polarization feed arrangement for the uplink portion of the lower-left donor patch antenna element 404c, whereas the opposing, horizontally oriented element feeds 406d and 406d′ result in a balanced, horizontal polarization feed arrangement for the uplink portion of the lower-right donor patch antenna element 404d.

For the donor downlink circuit, the donor antenna feed circuit board 72′ includes a donor downlink input port 410, which connects to a donor downlink circuit trace 412. The donor downlink circuit trace 412, in turn, connects to the upper-left donor antenna element 404a at a pair of opposing, vertically oriented element feeds 416a and 416a′. Similarly, the donor downlink circuit trace 412 connects to the upper-right donor antenna element 404b at a pair of opposing, vertically oriented element feeds 416b and 416b′. The opposing, vertically oriented element feeds 416a and 416a′ result in a balanced, vertical polarization feed arrangement for the downlink portion of the upper-left donor patch antenna element 404a; whereas the opposing, vertically oriented element feeds 416b and 416b′ result in a balanced, vertical polarization feed arrangement for the downlink portion of the upper-right donor patch antenna element 404b.

The donor downlink circuit trace 412 also connects to the lower-left donor antenna element 404c at a pair of opposing, vertically oriented element feeds 416c and 416c′. Similarly, the donor downlink circuit trace 412 also connects to the lower-right donor antenna element 404d at a pair of opposing, vertically oriented element feeds 416d and 416d′. The opposing, vertically oriented element ports 416c and 416c′ result in a balanced, vertical polarization feed arrangement for the downlink portion of the lower-left donor patch antenna element 404c; whereas the opposing, vertically oriented element ports 416d and 416d′ result in a balanced, vertical polarization feed arrangement for the downlink portion of the lower-right donor antenna element 404d.

The implementation of balanced antenna feeds for both the uplink and downlink circuits in this embodiment requires the use of an upper-left crossover 420a, an upper-right crossover 420b, a lower-left crossover 420c, and lower-right crossover 420d. The circuit also includes phantom crossovers 421a-d, that mirror the actual crossovers 420a-d, for phase equalization of the balanced antenna feed arrangements. The donor feed circuit board 72′ also includes a fifth crossover 420e between the upper and lower halves of the feed circuit. Again in this particular example, these crossovers and phantom crossovers are implemented by pin-type connectors through the circuit board and a short signal trace on the opposite side of the circuit board.

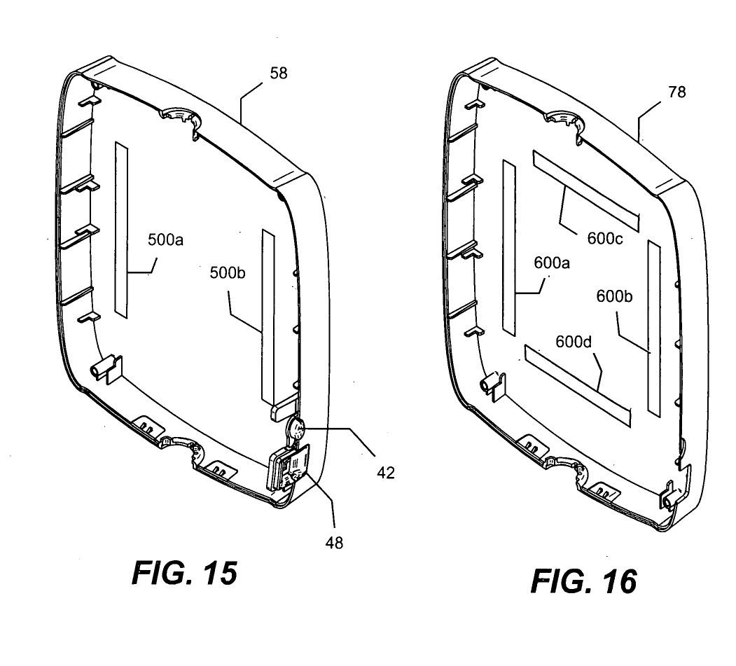

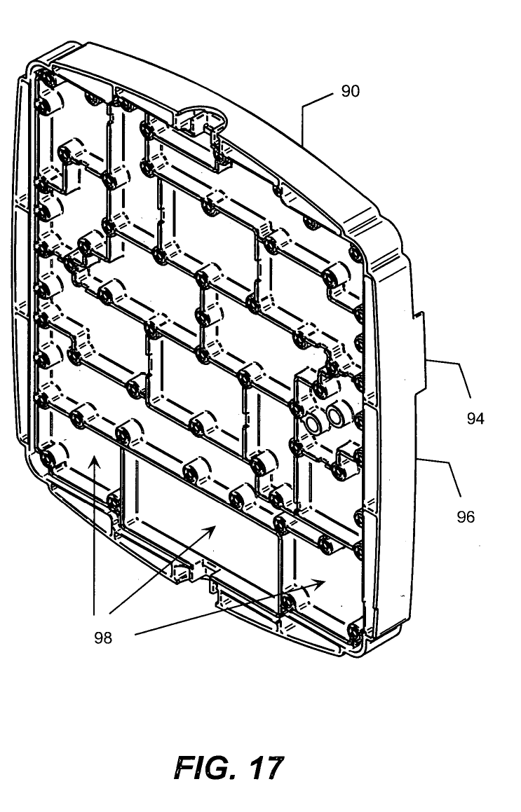

FIG. 15 is a perspective view of the interior of the server radome 58, which carries two parallel, vertically-oriented conductive parasitic strips 500a and 500b. Similarly, FIG. 16 is a perspective view of the interior of the donor radome 78, which carries four conductive parasitic strips 600a-d arranged in a square configuration. The parasitic strips are located in areas of high electromagnetic field strength generated by the antennas, but are not connected to the antenna circuit. Whereas the feedback circuits 33 and 37 are an internal mechanism to cancel the external feedback, the parasitic strips disposed in this manner are effective at altering the external signal to cancel a portion of the external feedback. The external feedback isolation is partly achieved through polarization isolation and partly achieved through antenna array directivity. The parasitic strips 500a-b and 600a-d illustrate that secondary electrically conducting elements that have a relatively large aspect ratio between major and minor dimensions may be oriented above and around the antenna array elements to induce scattering and additional feedback that alters and cancels the natural feedback that can occur between cross-polarized energy components between the server and donor antennas thereby decreasing the coupling between cross-polarized feed portion pair 20 and 16, and coupling between cross-polarized feed portion pair 14 and 24. The strips are most effective at altering polarization coupling components of an external feedback and do not have a substantial effect on the forward radiation patterns. In other words, the parasitic strips 500a-b and 600a-d interact with and interact upon the weak components of the electromagnetic fields near the server 12 and donor 20 antennas.

It can be appreciated that the strips 500a-b and 600a-d shown in FIG. 15 and 16 are oriented in principal vertical and horizontal orientations aligned with the principal polarization components of the server and donor antennas and that other orientations such as a slant 450 orientation may result in effective feedback reduction or cancellation. It can be appreciated that strip of varying widths may result in effective feedback cancellation and that filamentary strips or wires may result in effective feedback cancellation. The lengths of the strips 500a-b and 600a-d may be individually tailored to optimize a feedback reduction cancellation or reduction of the polarization component coupling between the donor 20 and server 12 antennas. The strips may be positioned on a variety of dielectric supports including the radome cover 58 or foam blocks or spaces including the use of conducting strips on a printed circuit board.

The side tabs 90, 92, 94 shown in FIGS. 7, 8, 9, 10, and 17 can perform a similar effect as the strips 500a-b and 600a-d to induce scattering and additional feedback that alters and cancels the natural feedback that can occur between cross-polarized energy components between the server and donor antennas thereby decreasing the coupling between cross-polarized feed portion pair 20 and 16, and coupling between cross-polarized feed portion pair 14 and 24. These side tabs 90, 92, 94 can be effective in acting upon the weak signal components of a feedback while not in the direct forward field of view of the radiating elements because the overall size of the repeater 10 is small in electrical units of the operational wavelength and proximal electrical features and conductors can play a significant role in forming the weak components of signals transmitted or coupled between the donor and server antenna elements. The size and position of the side tabs 90, 92, 94 are determined by empirical methods using conducting tape and later can be included in the molded and metalized plated plastic mounting plates 66 and 70. A continuous rim or wall 90 as shown in FIG. 17 can be effective at reducing a feedback between a donor and server side of the sandwiched repeater assembly.

FIG. 17 is a perspective view the donor-facing side of the server mounting plate 70 showing the isolation zones 98, which were described previously with reference to FIG. 8. Unlike FIG. 8, FIG. 17 shows the entire donor-facing side of the server mounting plate, included more then an dozen isolation zones 98 (arrows point to only three of the zones to avoid clutter in the figure. To reiterate, the isolation zones form compartments around certain sections of the electronics board 68 to isolate and reduce the electromagnetic energy radiating from these areas of the circuit board. This helps to reduce interference between circuit board elements and between the circuit board ands the antenna elements and feed circuits. These isolation zones are integrated into both mounting plates 66 and 70 and effectively isolate internal feedback of circuit elements of a double-sided printed circuit board assembly comprising a bidirectional amplifier 30. The mounting plates 66 and 70 have a substantially continuous electrically conducting surface resulting from plating the plastic body of the plates with an electrical conductor comprised of a copper layer followed by a nickel layer. The nickel layer is relatively free of oxidation over time that may otherwise result in deterioration of the conductivity between layers in the sandwich assembly. These isolation zones isolate feedback signals within a downlink circuit 32, feedback signals within an uplink circuit 34, and feedback signals between a downlink circuit 32 and an uplink circuit 34. The integration of these isolation zones within the mounting plates leads to reduced costs as compared to the use of discrete conducting enclosures and the multifunctional use of these isolation zones within the mounting plates allows a compact and low-cost sandwich assembly of the layers in the repeater 10. These isolation zones use a conductive gasket material along the ridge lines forming the individual cavities or zones 98 and the conductive gasket makes contacted with DC grounded areas on the printed circuit board assembly comprising the duplex repeater electronics board 68 sandwiched between mounting plates 66 and 70. In other words, there are conducting paths between all layers of grounds within the repeater 10 assembly.

FIG. 18 shows a detailed circuit block diagram of a preferred embodiment of the wireless repeater. This figure is a more detailed version of the higher-level block diagram shown in FIG. 1. The circuit 1200 shown in FIG. 18 includes a dual-polarization server antenna 12, which includes a downlink portion 14 having horizontal polarization, and an uplink portion 16 having vertical polarization. The circuit 1200 also includes a dual-polarization donor antenna 20, which includes a downlink portion 22 having vertical polarization, and an uplink portion 34 having horizontal polarization. A downlink signal path 36 extends from the downlink portion 22 of the donor antenna 20 to the downlink portion 14 of the server antenna 12. Also, an uplink signal path 38 extends from the uplink portion 16 of the server antenna to the uplink portion 24 of the donor antenna. The donor antenna 20 is configured to exchange RF communications with a carrier's base station, whereas the server antenna 12 is configured to exchange RF communications with a customer's wireless communication device or mobile unit. Thus, the downlink signal path refers to the communication path from the carrier's base station to the customer's wireless communication device, whereas the uplink signal path refers to the communication path from the mobile unit to the base station.

In the downlink signal path 36, the downlink signal is coupled from the downlink portion 22 of the donor antenna 20 to a low noise amplifier (LNA) 1201 for a first amplification stage for the downlink signal. The low noise amplifier 1201 is selected so as to not significantly increase the signal to noise ratio of the downlink signal. The downlink signal then passes through a directional coupler 1202 which couples the downlink signal and a feedback cancellation signal into an amplifier 1204, which will be explained further below. The downlink signal, as modified by the associated feedback cancellation signal, is then amplified by the amplifier 1204 and then coupled into a first bandpass filter (BPF) 1206, which is defined to have a center pass frequency of 1960 MHz and to output a receiving band signal in the receiving band of 1930 to 1990 MHz (the transmitting band of a base station), while filtering out unwanted frequencies outside the band. The first bandpass filter (BPF) 1206 provides uplink isolation and image filtering for the mixer 1208.

The receiving band signal is then inputted into a mixer 1208, which multiplies the receiving band signal with a synthesized local oscillator 1209 to produce an intermediate frequency (IF) signal at 315 MHz. That IF signal is then coupled into a balanced intermediate frequency amplifier (IF AMP) 1210. The IF signal is then supplied to one of the RF switches 1212a, 1212d, selectively, depending on which bandwidth is selected (i.e., 15 MHz provided by the SAW filter 1212b or 5 MHz provided by the filter 1212b) as determined by the controller 1276, which sends control signals to the RF switches 1212a, 1212c, 1212d, and 1212f. As determined by the selected bandwidth, the IF signal is inputted into surface acoustic wave the appropriate (SAW) filters 1212b or 1212e. The SAW filter 1212b is set to a passband frequency of 15 MHz, while the SAW filter 1212e is set to a passband frequency of 5 MHz. The respective outputs of the SAW filters 1212b, 1212e are then inputted into RF switches 1212c or 1212f, and then coupled into the mixer 1214 in order to be down converted from an IF signal into a RF signal using the synthesized local oscillator 1209. The RF signal is then inputted into the bandpass filter (BPF) 1216 having a center frequency of 1960 MHz for uplink isolation and to filter out the frequencies outside of the receiving band so as to again closely match the ideal receiving band.

The output signal from the bandpass filter 1216 is coupled to a variable gain amplifier 1218, which controls the output power of the downlink signal, thereby controlling overall system gain. The variable gain amplifier 1218 acts as a preamplifier if the gain is greater than or equal to unity, which is 0 dB or greater. The variable gain amplifier 1218 can also act as an attenuator when the gain is less than unity or less than 0 dB. The use of a variable gain amplifier 1218 as a control device for the signal amplitude control can provide a resolution control of the signal amplitude in one-half (0.5) and one (1.0) dB step sizes and provides uniform control of the signal amplitude. In one embodiment, the variable gain amplifier 1218 has a dynamic range of approximately 50 dB covering the range of output signal values having a gain of approximately minus twenty-five (−25) dB to plus twenty-three (+23) dB.

The output signal of the variable gain amplifier 1218 is then coupled with a driver 1220 which operates as a power amplifier pre-driver for the output signal of the variable gain amplifier 1218. The downlink signal outputted by the driver 1220 is inputted into another bandpass filter (BPF) 1222 also having a center frequency of 1960 MHz to filter out the frequencies outside of the receiving band so as to again closely match the ideal receiving band. The bandpass filter 1222 is then coupled to a power amplifier (PA) 1224 to further amplify the output signal from the bandpass filter 1222.

The outputted downlink signal from the power amplifier 1224 is inputted into a coupler 1226 that outputs into a lowpass filter (LPF) 1228, feeds into a RF power detector 1236, and feeds back to an attenuator 1230. The coupler is used for output power detection and output coupling to the downlink feedback path. The lowpass filter 1228 attenuates the downlink signal of harmonics from the power amplifier (PA) 1224, and then outputs to the downlink horizontal polarization downlink portion 14 of the server antenna 12. The RF power detector 1236 receives a sample portion of the processed downlink signal and measures the output power of the signal. The detector 1236 inputs the measurement of the RF output power into the controller 1276 through a buffer 1237 and an analog-to-digital converter (ADC) 1276e.

In the downlink feedback path, the attenuator 1230 controls the amplitude of the downlink signal in accordance with the selected band as determined by control signals received from the digital-to-analog converter (DAC) 1276h of the controller 50, and then outputs to a phase shifter 1232, which is also controlled by control signals from the digital-to-analog converter (DAC) 1276g of the controller 1276, in order to phase shift the signal in accordance with external feedback signals originating from the server antenna 12. The downlink signal outputted by the phase shifter 1232 is coupled to a delay circuit 1234 in order to delay the phase shifted downlink signal again in accordance with the external feedback signals originating from the server antenna 12. The output of the delay circuit 1234 can thus be inputted through the coupler 1202 and into the amplifier 1204. The output of the delay circuit 1234 is equal in amplitude and 180 degrees out of phase with the external feedback signals in order to effect cancellation thereof.

With respect to the uplink signal path 38, the circuit 1200 includes the uplink portion 16 of the server antenna 12, which couples the uplink signal into the uplink signal path. The uplink signal is coupled to a low noise amplifier (LNA) 1268 for a first amplification stage for the uplink signal, the low noise amplifier 1268 being selected so as to not significantly increase the signal to noise ratio of the uplink signal. The uplink signal then passes through a directional coupler 1266 which couples the uplink signal and a feedback signal into an amplifier 1264, which will be explained further below. The uplink signal or feedback signal coupled by the coupler 1266 is then amplified by the amplifier 1264 and then coupled into a first bandpass filter (BPF) 1262, which is defined to have a center pass frequency of 1880 MHz and to output a receiving band signal in the receiving band of 1850 to 1910 MHz (the transmitting band of a wireless telephone), while filtering out unwanted frequencies outside the band. The first bandpass filter (BPF) 1262 provides uplink isolation and image filtering for the mixer 1260.

The receiving band signal is then inputted into a mixer 1260 which multiplies the receiving band signal with a synthesized local oscillator 1269 to produce an intermediate frequency (IF) uplink signal at 315 MHz. That IF signal is then coupled into a balanced intermediate frequency amplifier (IF AMP) 1258. The IF signal is then inputted into RF switches 1256a or 1256d, selectively, depending on which bandwidth is selected (5 MHz or 15 MHz) as determined by the controller 1276, which sends control signals to the RF switches 1256a, 1256c, 1256d, and 1256f. As determined by the selected bandwidth, the IF signal is inputted into surface acoustic wave the appropriate (SAW) filters 1256b or 1256e. The SAW filter 1256e is set to a passband frequency of 15 MHz, while the SAW filter 1256b is set to a passband frequency of 5 MHz. The respective outputs of the SAW filters 1256b and 1256e are then inputted into RF switches 1256c or 1256f, depending on which bandpass filter has been selected. The uplink signal is then coupled into the mixer 1254 in order to be down converted from an IF signal into a RF signal using the synthesized local oscillator 1269. The RF signal is then inputted into the bandpass filter (BPF) 1252 having a center frequency of 1880 MHz for uplink isolation and to filter out the frequencies outside of the receiving band so as to again closely match the ideal receiving band.

The output signal from the bandpass filter 1252 is coupled to a variable gain amplifier 1250, which controls the output power of the uplink signal, thereby controlling overall system gain. The variable gain amplifier 1250 acts as a preamplifier if the gain is greater than or equal to unity, which is 0 dB or greater. The variable gain amplifier 1250 can also act as an attenuator when the gain is less than unity or less than 0 dB. The use of a variable gain amplifier 1250 as a control device for the signal amplitude control can provide a resolution control of the signal amplitude in one-half (0.5) and one (1.0) dB step sizes and provides uniform control of the signal amplitude. In one embodiment, the variable gain amplifier 1250 has a dynamic range of approximately 50 dB covering the range of output signal values having a gain of approximately minus twenty-five (−25) dB to plus twenty-three (+23) dB.

The output signal of the variable gain amplifier 1250 is then coupled with a driver 1248 which operates as a power amplifier pre-driver for the output signal of the variable gain amplifier 1250. The uplink signal outputted by the driver 1248 is inputted into another bandpass filter (BPF) 1246 also having a center frequency of 1880 MHz to filter out the frequencies outside of the receiving band so as to again closely match the ideal receiving band. The bandpass filter 1246 is then coupled to a power amplifier (PA) 1244 to further amplify the output signal from the bandpass filter 1246.

The outputted uplink signal from the power amplifier 1244 is inputted into a coupler 1242 that outputs into a lowpass filter (LPF) 1240, feeds into a RF power detector 1238, and feeds back to an attenuator 1274. The coupler is used for output power detection and output coupling to the uplink feedback path. The lowpass filter 1240 attenuates the uplink signal of harmonics from the power amplifier (PA) 1244, and then outputs to the uplink horizontal polarization uplink portion 24 of the donor antenna 20. The RF power detector 1238 receives a sample portion of the processed uplink signal and measures the output power of the signal. The detector 1238 inputs the measurement of the RF output power into the controller 1276 through a buffer 1239 and an analog-to-digital converter (ADC) 1276d.

In the uplink feedback path, the attenuator 1274 controls the amplitude of the uplink signal in accordance, with the selected band as determined by control signals received from the digital-to-analog converter (DAC) 1276a of the controller 1276, and then outputs to a phase shifter 1272, which is also controlled by control signals from the digital-to-analog converter (DAC) 1276b of the controller 1276, in order to phase shift the signal in accordance with external feedback signals originating from the donor antenna 20. The uplink signal outputted by the phase shifter 1272 is coupled to a delay circuit 1270 in order to delay the phase shifted uplink signal again in accordance with the external feedback signals originating from the server antenna 12. The output of the delay circuit 1234 can thus be inputted through the coupler 1202 and into the amplifier 1204. The output of the delay circuit 1234 is equal in amplitude and 180 degrees out of phase with the external feedback signals in order to effect cancellation thereof.

The variable gain amplifiers 1218 and 1250, the RF switches, the attenuators 1230 and 1274 and the phase shifters 1232 and 1272 are controlled by a controller 1276, which samples the RF output power of the downlink signal from the directional coupler 1226 and the output power of the uplink signal from the directional coupler 1242, both at predetermined periodic intervals, using the RF power detectors 1236 and 1238. The variable gain amplifiers 1218 and 1250 are connected to the controller 1276 via digital-to-analog converters (DAC) 1276f and 1276c, respectively.

As examples for implementations of the various components discussed above, The directional couplers 1202, 1226, 1242 and 1266 can be a DC17-73 manufactured by Skyworks Solutions, Inc. in Woburn, Mass. and can have an insertion loss of less than one (1) dB with a coupled port at a value of approximately minus eleven (−11) dB.

The controller 1276 may be implemented by a PIC16F873 device made by Microchip Technology, Inc. of Chandler, Ariz., or by other similar controller devices. Alternatively, the functions of the controller 1276 may also be performed by a custom application specific integrated-circuit (ASIC), a complex programmable logic device (CPLD), a system-on-a-chip (SOC) integrated circuit, a field programmable gate array (FPGA), or other similar programmable devices.

The RF power detectors 1236 and 1238 may be implemented using a RF logarithmic detector and controller AD8313 manufactured by Analog Devices, Inc. in Norwood, Mass. The use of a RF logarithmic detector provides a relatively wide dynamic range of signal amplitude detection and can provide accuracies of plus or minus three (±3) dB over a 70 dB dynamic range or plus or minus one (±1) dB over a 62 dB dynamic range.

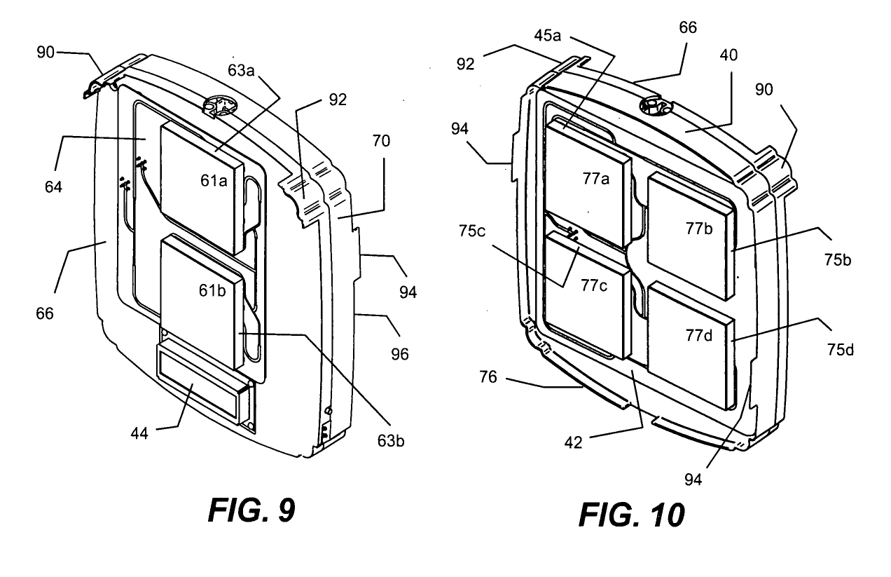

The various filters of the signal enhancer 1 may be implemented by “ceramic” band pass filters. For example, a conventional ceramic band pass filter can be used, where the filter has three (3) poles and is customized with a zero located at or near the adjacent band edge of the other operational transmit or receive band. The poles and zeros of the filter transfer function define locations of singularities within the s-plane conventionally used in filter analysis and design and are used as a measure of the complexity of the filter. Such filters are designed around the center frequency of 1960 MHz to pass the receiving frequency band of 1930 to 1990 MHz or around the center frequency of 1880 MHz to pass the transmitting frequency band of 1850 to 1910 MHz for the uplink signals to the base station (BS), which leaves a separation of 20 MHz between the signals. However, such bands though designed are not ideal and thus crossover points may occur between the responses of the bands, as illustrate in FIG. 9.

Conventional three (3) pole ceramic bandpass filters may be implemented by C031880E filters manufactured by Microwave Circuits, Inc. located in Washington D.C. for the transmitting frequency band of 1850 to 1910 MHz. Conventional three (3) pole ceramic bandpass filters may be implemented by C031960J filters manufactured by Microwave Circuits, Inc. for the receiving frequency band of 1930 to 1990 MHz.

In operation, the output signals from the RF power detectors 1236 and 1238 are inputted into the controller 1276. In order to provide a lower impedance input into the controller 1276, the output signals from the RF power detectors may be passed through a buffer stage 1237 and 1239, respectively, and through analog-to-digital converters (ADC) 1276e and 1276d, respectively. In the implementation of either the buffer stage or the ADC, either one or both devices may be discrete circuit elements or incorporated into either the RF power detectors 1236 and 1238 or the controller 1276 (as shown for this embodiment).

The controller 1276 compares the output power of each of the signal paths to predetermined operating output levels or to predetermined ranges of operating output levels. The controller 1276 then sends a signal to the variable amplifiers 1218 and 1250 to adjust their outputs. In one implementation of controlling the variable amplifiers 1218 and 1250, the control signals from the controller 1276 are first inputted into digital-to-analog converters (DAC) 1276f and 1276c, respectively, and then coupled to the variable amplifiers 1218 and 1250, respectively. As with the ADC, the DAC may be implemented either as a discrete circuit element as part of the RF power detectors 1236 and 1238 or the controller 1276. An example implementation for the DAC portion as a discrete device includes a LTC 1661 Micropower Dual ten-(10-) bit DAC from Linear Technology Corporation of Milpitas, Calif. The LTC 1661 DAC provides two accurate addressable ten-(10-) bit DACs, each of which has a high degree of linearity, in a small package.

In the preferred embodiment, the delay circuits 1234 and 1270 are fixed to provide a delay of 12 ns, for example as determined by experiment. In another variation of the preferred embodiment, the delay circuits 1234 and 1270 may also be variable delay circuits that are controlled via control signals from the controller 1276 in order to be band selectable and configurable after the unit has been installed in its operational location. In this manner, the delay setting can be an adjustable parameter of the feedback cancellation circuits similar to the phase and gain settings.

In this particular circuit 1200, frequency channel selection is enabled by changing the frequency setting of the local oscillators 1209 in the downlink signal path 36 and 1269 in the uplink signal path 38. In other words, the local oscillators 1209 and 1269 tune the wireless repeater to a desired frequency channel, which established the center frequency of the frequency band of the channel. The bandwidth of the channel is set by the SAW switching block 1212a-f in the downlink signal path and 1256a-f in the uplink signal path. In this particular circuit, channel bandwidths of 5 MHz and 15 MHz are provided through a balanced filter arrangement. However, those skilled in the field of electronics will understand how to implement other selectable bandwidths, if desired. The frequency channel profile of the wireless repeater, including the available center frequencies and channel bandwidths, is determined by the controller 1276, which controls the local oscillators 1209 and 1269 and the SAW filter switching blocks 1212a-f and 1256a-f. Thus, the frequency channel profile can be changed through programming running on the controller 1276, which can be configured locally and remotely through the wireless transmitter/repeater 46 and the USB port 48, as described previously with reference to FIG. 6. The controller 1276 also controls the attenuator 1230 and the phase shifter 1232 in the downlink feedback cancellation circuit, as well as the attenuator 1274 and the phase shifter 1272 in the uplink feedback cancellation circuit. This enables reconfiguration of the feedback cancellation circuit locally and remotely through the wireless transmitter/repeater 46 and the USB port 48. The display 1278 is also controlled by the controller 1276, which enables reconfiguration of the channel indicators. The connection between the controller 1276 and the channel selection button 42, display 44, wireless transmitter/receiver 46 and the USB port 48 are also shown in FIG. 18.

In view of the foregoing, it will be appreciated that present invention provides significant improvements in wireless repeaters. It should be understood that the foregoing relates only to the exemplary embodiments of the present invention, and that numerous changes may be made therein without departing from the spirit and scope of the invention as defined by the following claims.

The invention claimed is:

1. A wireless repeater, comprising:
a duplex repeater electronics board;
a donor mounting plate carrying the repeater electronics board one side and a donor antenna feed circuit on an opposing its opposing side;
a server mounting plate carrying the repeater electronics board one side and a server antenna feed circuit on an opposing its opposing side; and
the donor mounting plate, the server mounting plate, and the duplex repeater electronics board affixed to each other to form an integral housing, whereby the donor antenna is configured for orientation in an operable donor direction for exchanging duplex cellular communication signals with one or more base stations, and the server antenna is configured for orientation in an operable server direction for exchanging duplex cellular communication signals with one or more wireless telephone units.

2. The wireless repeater of claim 1, wherein one or both of the server and donor mounting plates comprise walls forming one or more isolation zones substantially enclosing certain portions of the electronic board to reduce the release of electromagnetic energy radiating from these zones of the electronic board.

3. The wireless repeater of claim 1, wherein one or both of the server and donor mounting plates comprise one or more side walls to reduce the release of electromagnetic energy radiating from these zones of the electronic board.

4. The wireless repeater of claim 1, wherein one or both of the server and donor mounting plates comprise one or more corner tabs for reducing the amount of energy radiated by the donor antenna that propagates around the common housing and into the server antenna.

5. The wireless repeater of claim 1, wherein one or both of the server and donor mounting plates comprise one or more asymmetric sets of corner tabs or side tabs for reducing the amount of energy radiated by the donor antenna that propagates around the common housing and into the server antenna.

6. The wireless repeater of claim 1, further comprising:
a user-operable frequency range selector for identifying a selected frequency range;
a display for showing information connoting the selected frequency range; and
wherein the wireless repeater is operable for providing wireless repeater service within the selected frequency range.

7. The wireless repeater of claim 1, further comprising:
a first radome covering the donor antenna;
a second radome covering the server; and
one or more parasitic conductors carried by the first or second radome.

8. A wireless repeater, comprising:
a duplex repeater electronics board;
a donor mounting plate carrying the repeater electronics board one side and a donor-antenna feed circuit on an opposing its opposing side;
a server mounting plate carrying the repeater electronics board one side and a server antenna feed circuit on an opposing its opposing side;
the donor mounting plate, the server mounting plate, and the duplex repeater electronics board affixed to each other to form an integral housing, whereby the donor antenna is configured or orientation in an operable donor direction for exchanging duplex cellular communication signals with one or more base stations, and the server antenna is configured for orientation in an operable server direction for exchanging duplex cellular communication signals with one or more wireless telephone units; and
wherein one or more of the donor mounting plate and the server mounting plate comprise one or more walls forming one or more isolation zones substantially enclosing certain portions of the electronic board to reduce the release of electromagnetic energy radiating from these zones of the electronic board.

9. The wireless repeater of claim 8, wherein one or both of the server and donor mounting plates comprise one or more corner tabs for reducing the amount of energy radiated by the donor antenna that propagates around the common housing and into the server antenna.

10. The wireless repeater of claim 8, wherein one or both of the server and donor mounting plates comprise one or more side tabs for reducing the amount of energy radiated by the donor antenna that propagates around the common housing and into the server antenna.

11. The wireless repeater of claim 8, wherein one or both of the server and donor mounting plates comprise one or more asymmetric sets of corner tabs and side tabs for reducing the amount of energy radiated by the donor antenna that propagates around the common housing and into the server antenna.

12. The wireless repeater of claim 11, further comprising:
a first radome covering the donor antenna;
a second radome covering the server; and
one or more parasitic conductors carried by the first or second radome.

13. The wireless repeater of claim 12, further comprising:
a user-operable frequency range selector for identifying a selected frequency range;
a display for showing information connoting the selected frequency range; and
wherein the wireless repeater is operable for providing wireless repeater service within the selected frequency range.

14. A wireless repeater, comprising:
a duplex repeater electronics board;
a donor antenna;
a server antenna;
a first radome covering the donor antenna;
a second radome covering the server; and
one or more parasitic conductors carried by one or both of first and second radomes.

15. The wireless repeater of claim 14, wherein the first radome and the second radome carry one or more of the parasitic conductors.

16. The wireless repeater of claim 15, wherein the parasitic conductors comprise elongated strips, and the first and second radomes each carry two substantially vertical parasitic strips or four parasitic strips arranged in a square configuration.

17. The wireless repeater of claim 16, further comprising:
a user-operable frequency range selector for identifying a selected frequency range;
a display for showing information connoting the selected frequency range; and
wherein the wireless repeater is operable for providing wireless repeater service within the selected frequency range.

18. The wireless repeater of claim 1, wherein one or both of the server and donor mounting plates comprise walls forming one or more isolation zones substantially enclosing certain portions of the electronic board to reduce the release of electromagnetic energy radiating from these zones of the electronic board.

19. The wireless repeater of claim 1, wherein one or both of the server and donor mounting plates comprise one or more of the following features to reduce the release of electromagnetic energy radiating from these zones of the electronic board: side walls, corner tabs and side tabs.

20. The wireless repeater of claim 19, one or both of the server and donor mounting plates comprise one or more asymmetric sets of corner tabs or side tabs for reducing the amount of energy radiated by the donor antenna that propagates around the common housing and into the server antenna.
